(19) United States
(12) Patent Application Publication
(10) Pub. No.: US 2002/0156668 A1
(43) Pub. Date: Oct. 24, 2002

(54) Remote project development method and system

(76) Inventors: Martin E. Morrow, Indianapolis, IN (US); Chun-An Chen, Indianapolis, IN (US)

Correspondence Address: Woodard, Emhardt, Naughton, Moriarty and McNett, Bank One Center/Tower, Suite 3700, 111 Monument circle, Indianapolis, IN, 46204-5137, US

(21) Appl. No.: 09/788,200

(22) Filed: Feb. 16, 2001

(51) Int. Cl. G06F 17/60

(52) U.S. Cl. 705/8; 705/37

(57) ABSTRACT

A project is developed using a community of remotely located developers over a computer network. An overseer of the project contracts with a customer to develop a project, and the overseer posts a description of the project at a site that is accessible by the community of developers. Bids for the project are received from the developers over the computer network. The project is awarded to at least one of the developers. The overseer manages development of the project by the selected developer and supplies the customer a completed project.

### BACKGROUND OF THE INVENTION

The present invention generally relates to project development systems, and more specifically, but not exclusively, relates to a system and method for developing projects between remotely located customers and developers.

Companies and organizations around the world have an increasing need for computer software applications in order to update their business systems. Two main approaches have generally been used to develop software applications: (1) maintain an internal staff to support project development; or (2) outsource the project to outside developers. A number of drawbacks arise from internally developing software. Maintaining an internal development staff tends to be prohibitively expensive for small and medium sized companies (or organizations). A permanent staff of developers is paid irregardless of workload.

In addition, the staff may not have the skills or expertise to develop the project. One remedy is to send the developers from the staff to training. However, training can be rather costly. Another remedy is to recruit qualified personnel to become members of the staff. The pool of talent is normally local talent, and sometimes developers are recruited from out of state. Staff members are almost never recruited internationally, because of the expense of obtaining visas for employees and language/cultural differences. In foreign countries, such as India, there is a large population of highly qualified software developers, but factors such as travel costs and cultural differences leaves this pool largely untapped. In fast growing and highly diverse industries, such as the software industry, this results in a shortage of staff members, because companies can only recruit in limited geographic areas. Highly skill employees are always in demand and therefore high turnover rates can exist due to bidding wars between companies. Maintaining a low turnover rate for highly skilled employees can be costly for small and even large companies.

In the outsourcing approach, there are many ways that outside contractors try to fulfill the needs of companies for software development. Certain large software companies specialize in providing development services in order to relieve their clients the expense of maintaining developer staffs. These large contractors basically face the same employee recruiting and retention problems faced by their clients. Another type of contractor is the small “boutique” contractor. While the boutique contractors can fill specific needs, these boutiques lack the broad and diverse background to meet the requirements of clients operating in diverse and complex technical environments. Like their larger counterparts, the boutique contractors still face employee recruiting and retention problems.

With the advent of the Internet and the open source software movement, another type of service has arisen generally referred to as a “matchmaking” service. In this service, a matchmaker maintains an Internet site that facilitates contacts between companies and software developers. The companies post development projects on the site, and the independent software developers directly contact the posting company. The matchmaker only introduces the two parties and does not take an active role in the development process. The relationship between the two parties is still only a contractor relationship. Since the matchmaker generally takes an inactive role, the reputation of the bidding developers can be suspect. The developer may not have the requisite skills or inclination to successfully manage the project. This problem is exaggerated with “free” open source software, because there is no financial motivation for developers to develop the software.

Thus, there remains a need for an improved technique for developing projects.

### SUMMARY OF THE INVENTION

One form of the present invention is a unique method for developing projects between a customer and a number of developers. Other forms concern a unique method for screening projects, a system for developing projects and an apparatus for adjusting bids of developers based on reputation.

In a further form, a customer contracts to have a project developed. A description of the project is posted at a site on a computer network, and the computer network is accessible by various developers. Over the computer network, bids for the project are received from one or more of the developers. The project is awarded to a selected developer based on the bids. The development of the project by the selected developer is administered, and a completed project is supplied to the customer.

In another form, a project development server is operatively coupled to one or more developer computers over a computer network. The server is operatively coupled to a customer computer over the computer network. The server receives a signal corresponding to a request for development of a project from the customer computer over the computer network. Signals corresponding to a description of the project are sent to the developer computers over the computer network. Over the computer network, the server receives signals corresponding to one or more evaluations of the project from the developer computers. A signal corresponding to an acceptance of the project based at least in part on the evaluations is sent to the customer computer.

A further form concerns a system for developing projects between a customer and a developer. A description of the project is posted at a server on a computer network, and the server is accessible by various developers over the computer network. Over the computer network, the server receives bids for the project from one or more of the developers. The project is awarded to a selected developer based on the bids. The development of the project by the selected developer is administered, and a completed project is supplied to the customer.

Still yet another form concerns a computer-readable device that includes logic executable by a computer to adjust a bid for a project from a developer based on reputation. The computer receives the bid for the project from the developer over a computer network, and the computer maintains a reputation score for the developer. The computer calculates an adjusted bid, which corresponds to the bid from the developer proportionally adjusted with respect to the reputation score of the developer, and the computer provides the adjusted bid.

Other forms, embodiments, objects, features, advantages, benefits and aspects of the present invention shall become apparent from the detailed drawings and description contained herein.

### BRIEF DESCRIPTION OF THE DRAWINGS

FIG. 1 is a diagrammatic view of a communication system.

FIG. 2 depicts a flow diagram illustrating one process for developing a project over the communication system shown in FIG. 1.

FIG. 3 depicts a computer generated home display screen.

FIG. 4 depicts a computer generated user registration display screen.

FIGS. 5A-B show a customer registration form.

FIG. 6 shows a developer registration form.

FIGS. 7A-B show a developer profile entry form.

FIG. 8 depicts a flow diagram illustrating one process for screening projects.

FIGS. 9A-D show a project request entry form.

FIGS. 10A-B depict a computer generated administrative dashboard display screen.

FIGS. 11A-C depicts a computer generated project request display screen.

FIG. 12 shows a job type template entry form.

FIG. 13 depicts a computer generated project screening display screen.

FIGS. 14A-B show a project screening entry form.

FIG. 15 depicts a flow diagram illustrating one process for defining technical specifications for a project.

FIG. 16 depicts a flow diagram illustrating one process for constructing a project.

FIG. 17 depicts a computer generated bid listing display screen.

FIG. 18A shows a bid entry form.

FIG. 18B shows a bid confirmation form.

FIG. 19 depicts a flow diagram illustrating one process for evaluating bids.

FIG. 20 depicts a flow diagram illustrating one process for testing projects.

FIG. 21 depicts a flow diagram illustrating one process for implementing projects.

FIG. 22 depicts a computer generated developer workspace display screen.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the art that some of the features which are not relevant to the invention may not be shown for the sake of clarity.

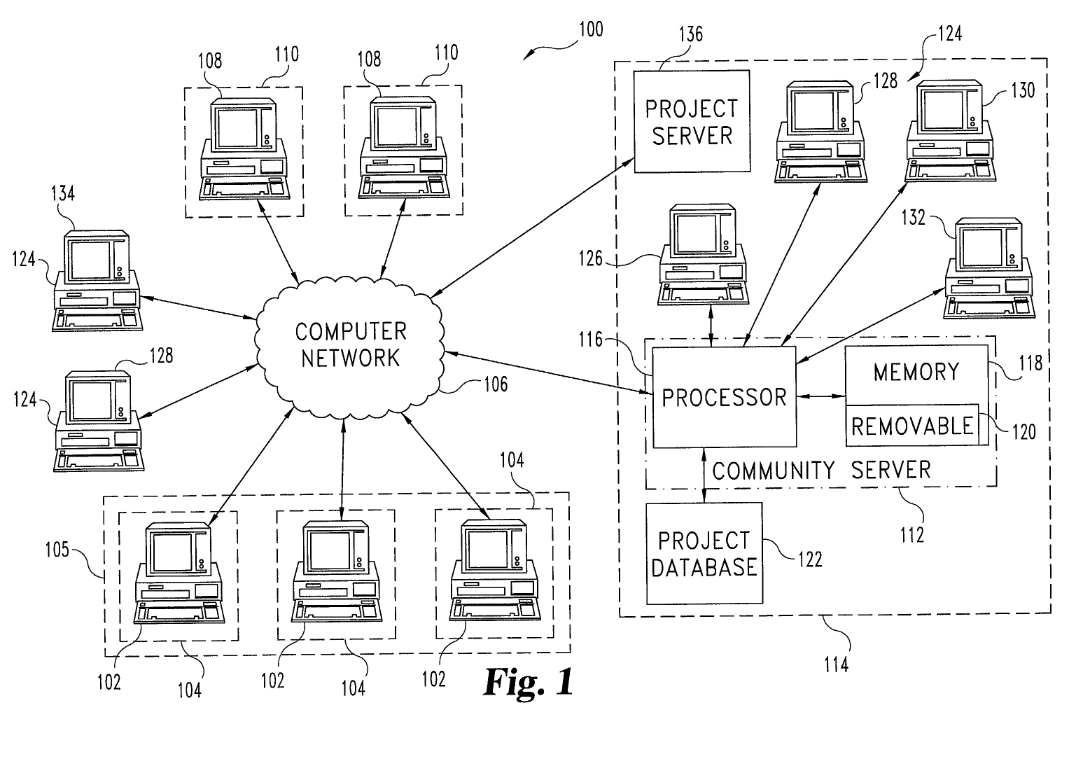

FIG. 1 depicts a communication system 100 according to one embodiment of the present invention in a diagrammatic form. System 100 includes developer computers 102 located at remote developer sites 104. Collectively, developers using the developer computers form a virtual developer community 105. Developer computers 102 are operatively coupled to a computer network 106. Customer computers 108, which are located at remote customer sites 110, are also operatively coupled to the computer network 106. Remote sites 104 and 110 can be located in different cities, states, and/or countries. Computers 102 and 108 can include personal computers, computer terminals, personal digital assistants (PDA's), and/or other types of devices generally known to those skilled in the art. Computers 102 and 108 have software that allows them to transmit and receive information from the computer network 106. The software on computers 102 and 108 can include web browsers, email software, instant messaging software, proprietary software and other types of software generally known to those skilled in the art. In one form, computers 102 and 108 are personal computers that have web browser and email software. The computer network 106 can include the Internet or other Wide Area Network (WAN), a local area network (LAN), a proprietary network such as provided by America OnLine, Inc., a combination of these, and/or a different type of network generally known to those skilled in the art. In one form, computer network 106 is the Internet. The Internet provides an international forum for marketing to customers and recruiting of developers.

A developer/customer community server 112, which is located at a local site 114, is operatively coupled to the computer network 106. In one form, the community server 112 includes a web server. In another form, the community server 112 is a Linux web server. The community server 112 includes a processor 116 and memory 118 operatively coupled to the processor 116. The processor 116 may be comprised of one or more components. For a multi-component form of the processor 116, one or more components can be located remotely relative to the others, or configured as a single unit. Furthermore, processor 116 can be embodied in a form having more than one processing unit, such as a multiprocessor configuration, and should be understood to collectively refer to such configurations as well as a single-processor-based arrangement. One or more components of processor 116 may be of the electronic variety defining digital circuitry, analog circuitry or both. Processor 116 can be of a programmable variety responsive to software instructions, a hardwired state machine, or a combination of these. Memory 118 can include one or more types of solid state electronic memory, magnetic memory, or optical memory, just to name a few. Memory 118 includes removable memory device 120. Device 120 can be in the form of a nonvolatile electronic memory unit, an optical disc memory (such as a DVD or CD ROM); a magnetically encoded hard disc, floppy disc, tape, or cartridge media; or a combination of these memory types.

As illustrated in FIG. 1, a project database 122 is operatively coupled to the community server 112. The project database 122 is configured to store information about projects, customers, and developers. Database 122 can be a standard file, a combination of files, a standard database program, a relational database, a SQL (Structured Query Language) database, and/or other types of data storage structures as generally known by those skilled in the art. In one from, the database 122 is a SQL database. Although the database 122 is illustrated as being separate from the community server 112, it should be appreciated that the database 122 can be integrated into the community server 112.

As shown, a number of project management computers 124 are operatively coupled to the community server 112. These management computers 124 include an administrator computer 126, a project manager computer 128, a quality manager computer 130, an operations group computer 132 and a marketing/sales computer 134. With administrator computer 126, an administrator administers the community server 112 and project database 122. For example, an administrator can assign security privileges, review projects, and assign managers to projects. As will be described in further detail below, a project manager can manage numerous projects through project manager computer 128. Testing and other quality control operations can be performed by a quality manager using quality manager computer 130, and an operations group can access the community server 112 with operations group computer 132. One benefit of the present invention is that the administrators, managers, operations personnel and salespersons (project overseers) have an ownership stake in the projects. These project overseers have an incentive for having their projects succeed, because any project failures directly impact them as a group.

Computers 124 can be directly coupled to server 112 or indirectly coupled to server 112 through the computer network 112. As illustrated, a remotely located salesperson using sales computer 134 can access community server 112 through the computer network 106. Computers 124 can include personal computers, computer terminals, PDA'S, and/or other types of devices generally known to those skilled in the art. The software on computers 124 can include web browsers, email software, instant messaging software, proprietary software and other types of software generally known to those skilled in the art. In one form, the software on computers 124 includes web browsers and email software.

A project server 136 is operatively coupled to the computer network 106. Although one project server 136 is shown, it should be appreciated that multiple project servers 136 can be used. Project server 136 is used for testing of software applications and delivering the applications. In one form, the project server 136 is directly coupled to computer network 106. It should be appreciated that the project server 136 can be operatively coupled to the computer network 106 through server 112.

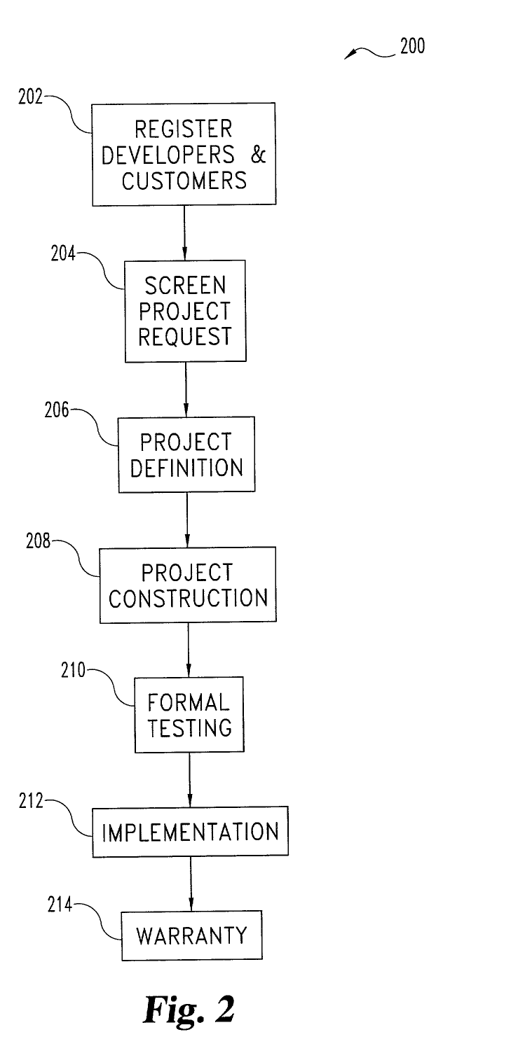

A method of developing a project according to one embodiment of the present invention is illustrated with flow diagram 200, which is shown in FIG. 2. While the method will be described in reference to communication system 100, it should be understood that portions of the method can be performed using other types of communication networks, such as telephone networks and postal networks. Examples of different types of interfaces for this method will be described below. The present invention is not intended to be limited to the interfaces described below and shown in the drawings. Other types of interfaces generally known by those skilled in the art are also contemplated to be incorporated alternatively or additionally into the present invention. One advantage of using computer network 106, especially the Internet, is that transaction costs are reduced and developers are universally accessible. In this particular form, the computer network 106 includes the Internet so that customers and developers can easily access the community server 112, and the projects concern computer software applications. It should be understood that other types of projects can be developed using this method. By way of non-limiting example, legal projects, accounting projects, media development projects, web design projects, entertainment (film/television) projects, sales/marketing projects, and product design projects can be developed using this method.

In a registration phase 202, customers and developers register with the community server 112. Salespersons with sales computers 134 can also market to customers and can recruit developers over the computer network 106. For example, the salesperson can join discussion groups in order to recruit potential customers. In addition, web based advertising on popular web sites can be used to promote the program to potential developers.

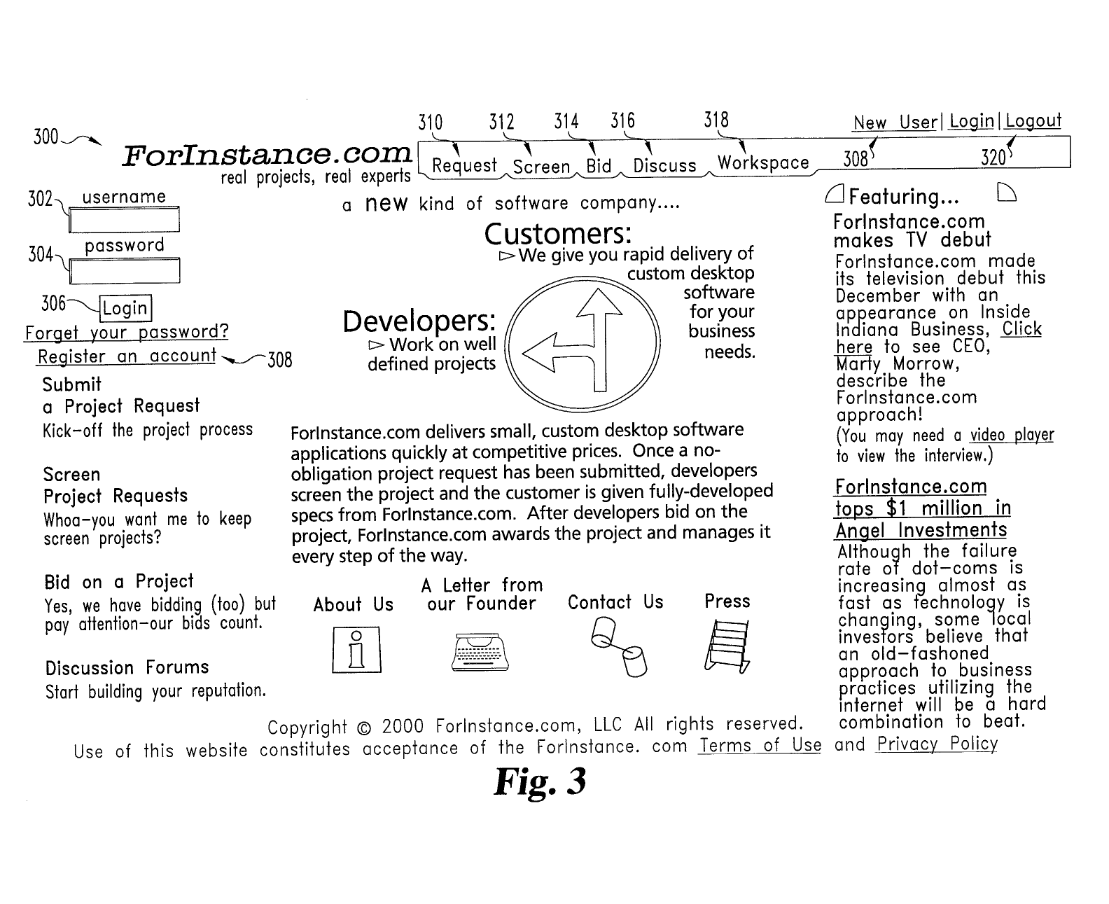

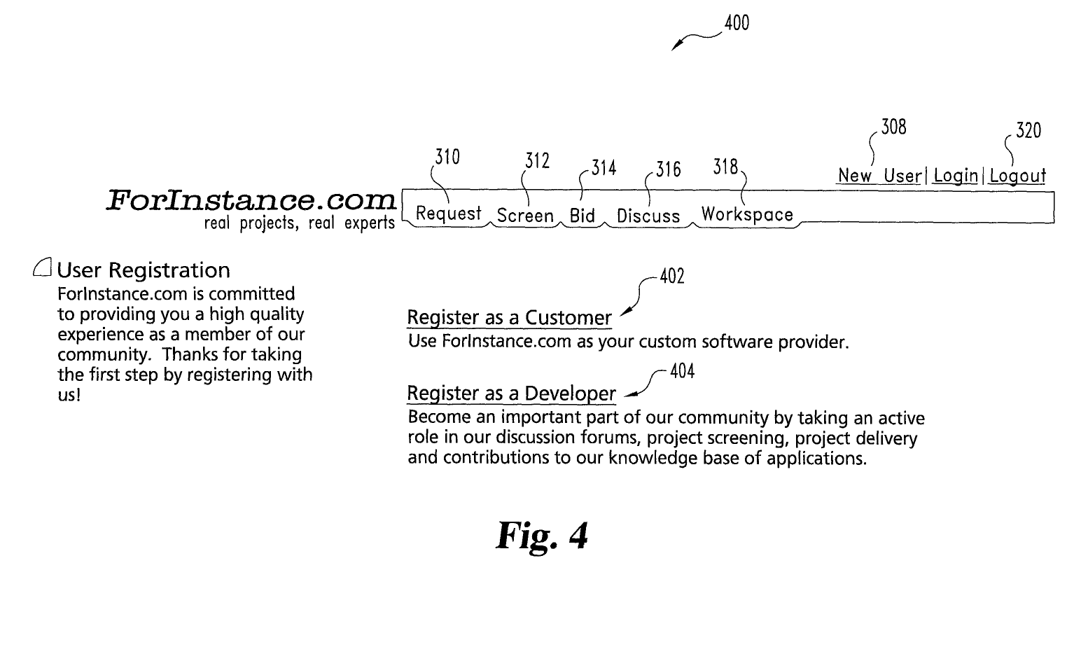

Once a person (customer or developer) wishes to participate, the person accesses a web site maintained by community server 112. An example of a home page 300 for this web site is shown in FIG. 3. If the person already has an account, the person can login to server 112 by entering a username and password into a username field 302 and password fields 304, respectively. By selecting login button 306, the person completes the login process. Screen 300 further includes a register link 308 for registering new accounts, a request button 310 for submitting project requests, a screen button 312 for screening projects, a bid button 314 for bidding on projects, a discussion button 316 for accessing discussion groups, a workspace button 318 to access pertinent project information, and a logout link 320 for logging off the community server 112. If a user selects the register link 308, a registration screen 400 (FIG. 4) is shown. To register as a customer, the user selects a customer registration link 402. The user selects a developer registration link 404 in order to register as a developer.

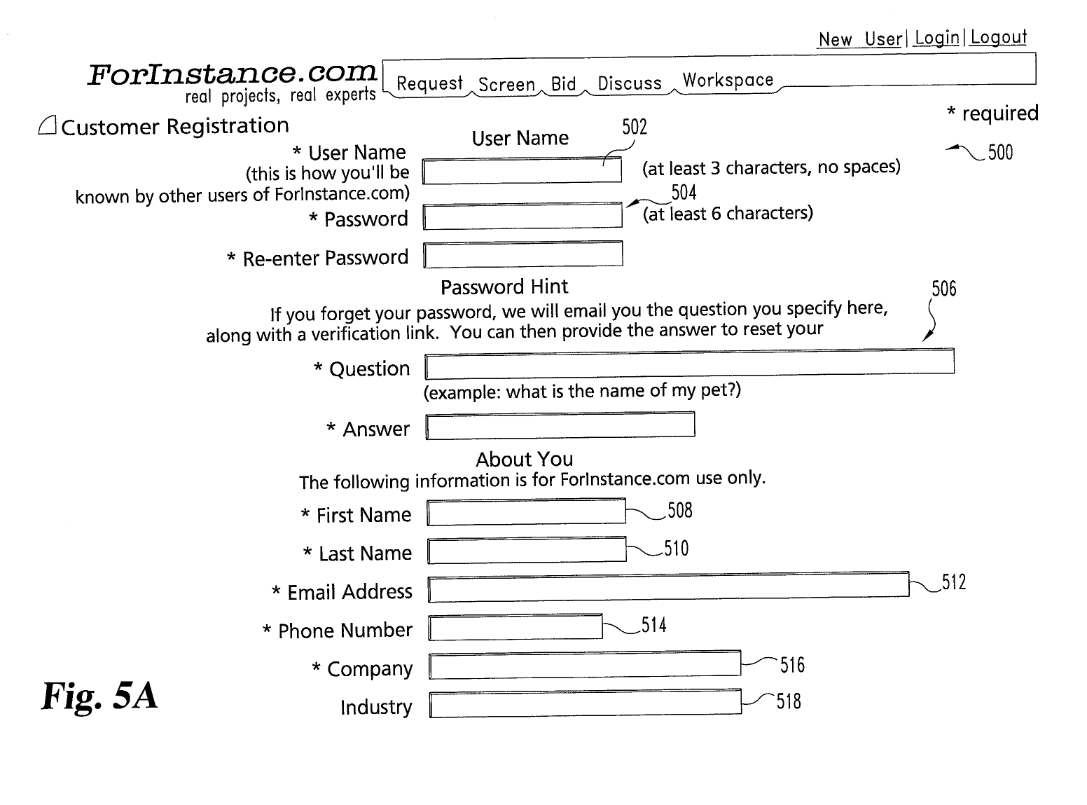

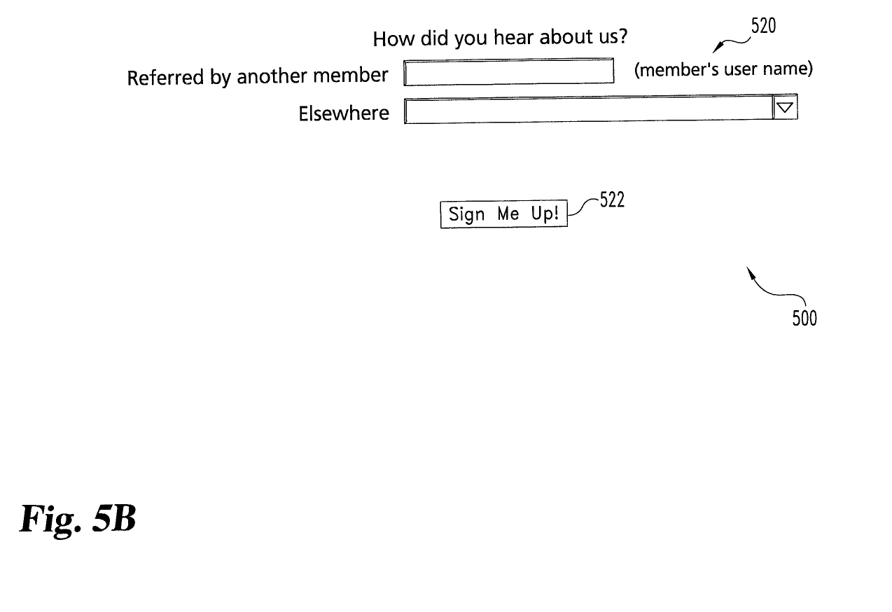

An example of a customer registration form 500, which is generated by server 112, is shown in FIGS. 5A-B. Form 500 includes a user name field 502 for entering a user name, and password fields 504 for entering and confirming the entered password. Password hint fields 506 are used in case the customer forgets the password. The first name, last name, email address, phone number, company name, and industry of the customer are respectively entered into fields 508, 510, 512, 514, 516 and 518. Personal information about the customer will not be made available to other customers or developers. Sales referral information is entered into fields 520, and the customer registration form 500 is submitted by selecting a sign-up button 522. It should be appreciated that customer registration form 500 can request additional information and/or omit certain fields. The information entered in form 500 will be used to help screen projects and maintain customer history information.

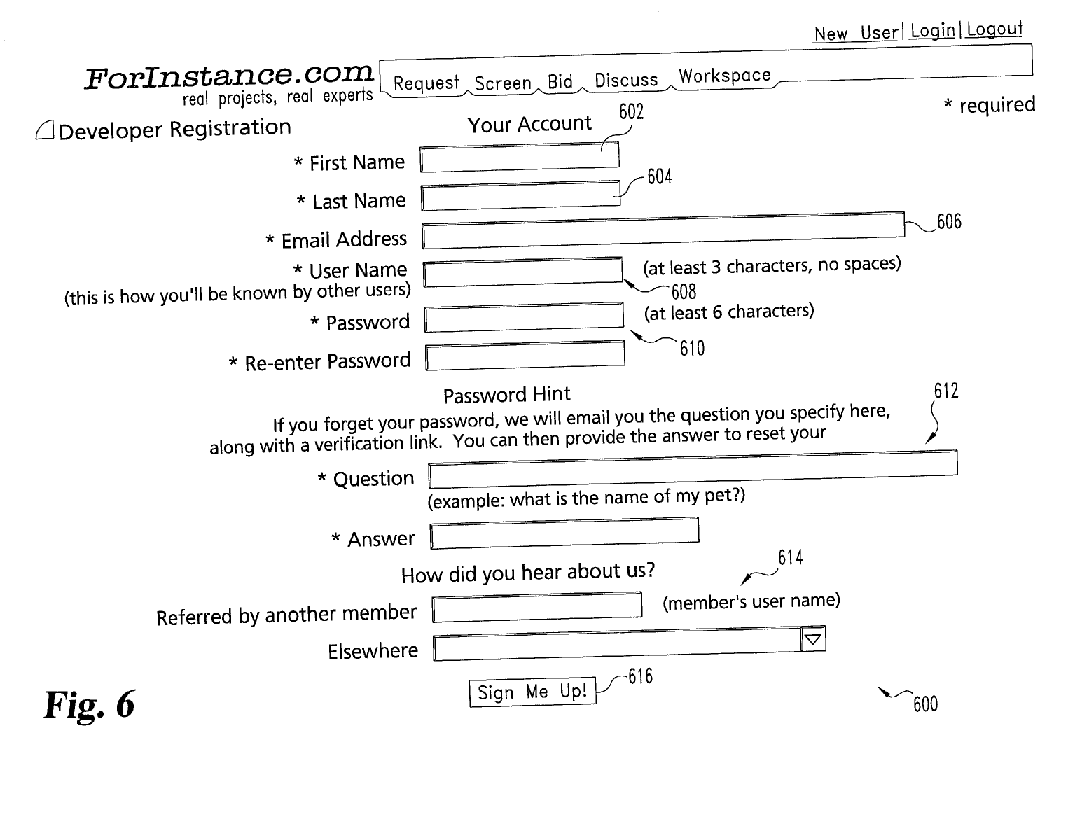

A sample developer registration form 600, which is sent by server 112 to developer computer 104, is shown in FIG. 6. The first name, last name and email address of the developer are respectively entered into fields 602, 604 and 606. The username for the developer is entered into username field 608 and a selected password is entered into fields 610. In case the developer forgets the password, password hint information is entered into password hint fields 612. Referral and sales information is entered into referral fields 614. The developer signs up by selecting sign-up button 616. It should be understood that form 600 can omit certain fields and/or request additional information.

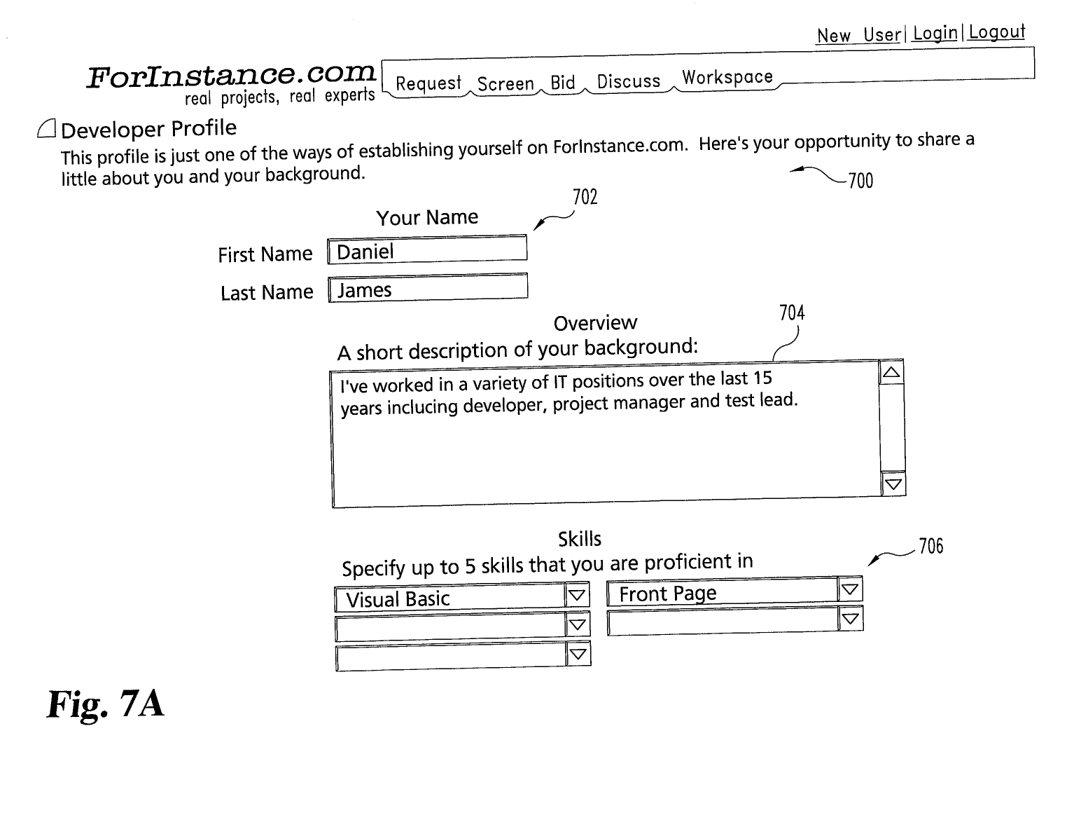

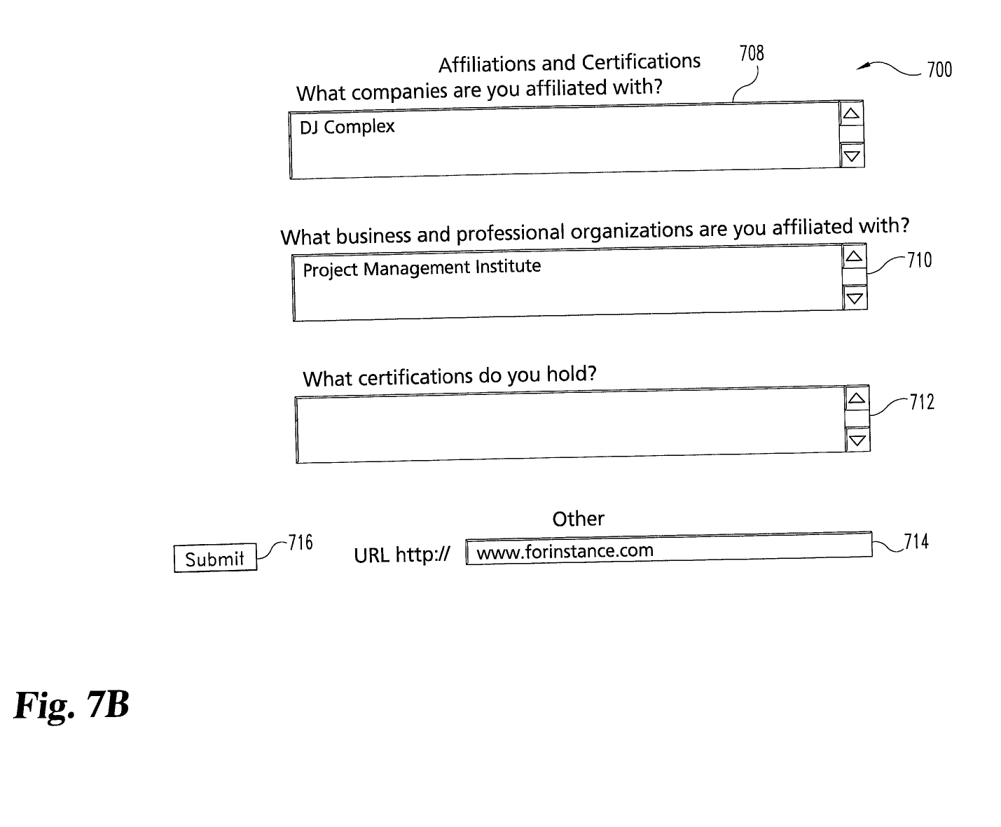

In one embodiment of the present invention, once the developer registration form 600 is submitted, sever 112 requests additional profile information about the developer. It should be appreciated that the developer can enter and edit this profile information at other times after registration. The entered profile information is later used to recruit qualified developers for projects and to ensure that a developer has the requisite skills for a project. A developer profile form 700 is shown in FIGS. 7A-B. The name of the developer can be edited in fields 702. The developer can enter a short background description in field 704, and any skills the developer has can be entered into fields 706. Any companies the developer is affiliated with can be entered into field 708. Professional affiliations and certifications can be entered into fields 710 and 712, respectively. A Universal Resource Locator (URL) address for a developer website can be entered into field 714. The developer submits the profile form 700 to the community server 112 by selecting a submit button 716. It should be appreciated that certain fields can be omitted and/or added to form 700.

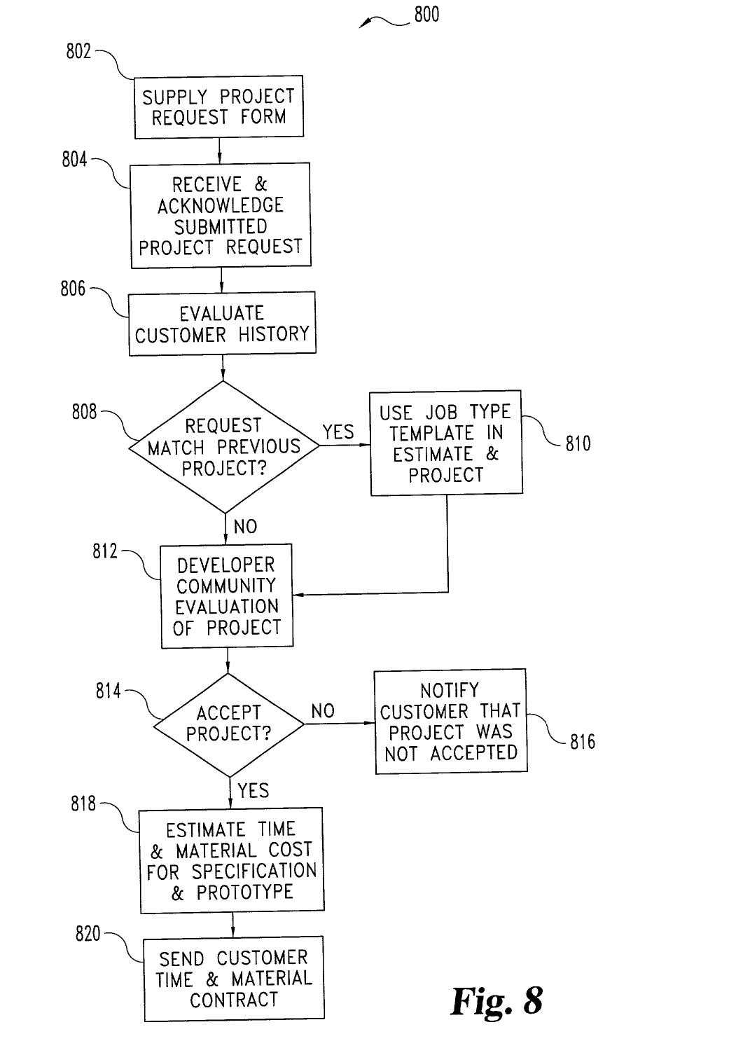

In screening phase 204 (FIG. 2), project requests submitted from customers are reviewed and screened. A more detailed view of the screening phase 204 according to one embodiment of the present invention is illustrated with flow chart 800 in FIG. 8. After the customer logs into the server 112, the customer can select the request button 310 (FIG. 3) in order to submit a project request. In response, server 112 sends a project request form to the customer computer 108 over the computer network 106. Alternatively, the customer can call the administrator, and the administrator can enter the project request information with the administrator computer 126. It should be understood that a person (overseer) can take on many roles during development of a project. For example, the administrator can also act as a project manager or quality manager. Although the project development method according to the present invention will be described below in reference to software application development, it should be appreciated that a variety of projects can be developed using this method. By way of nonlimiting examples, these projects can include software applications, accounting services, legal services, web development, and media development (such as music and movies). In one form, the project is a software application.

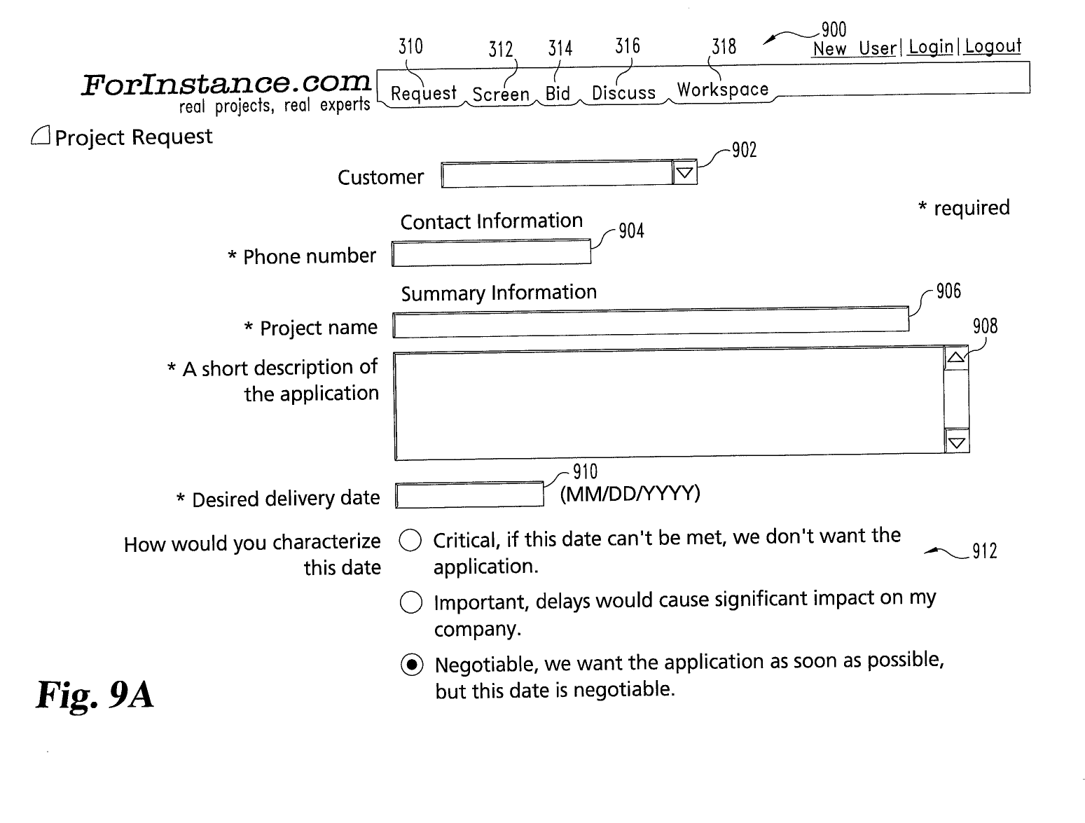

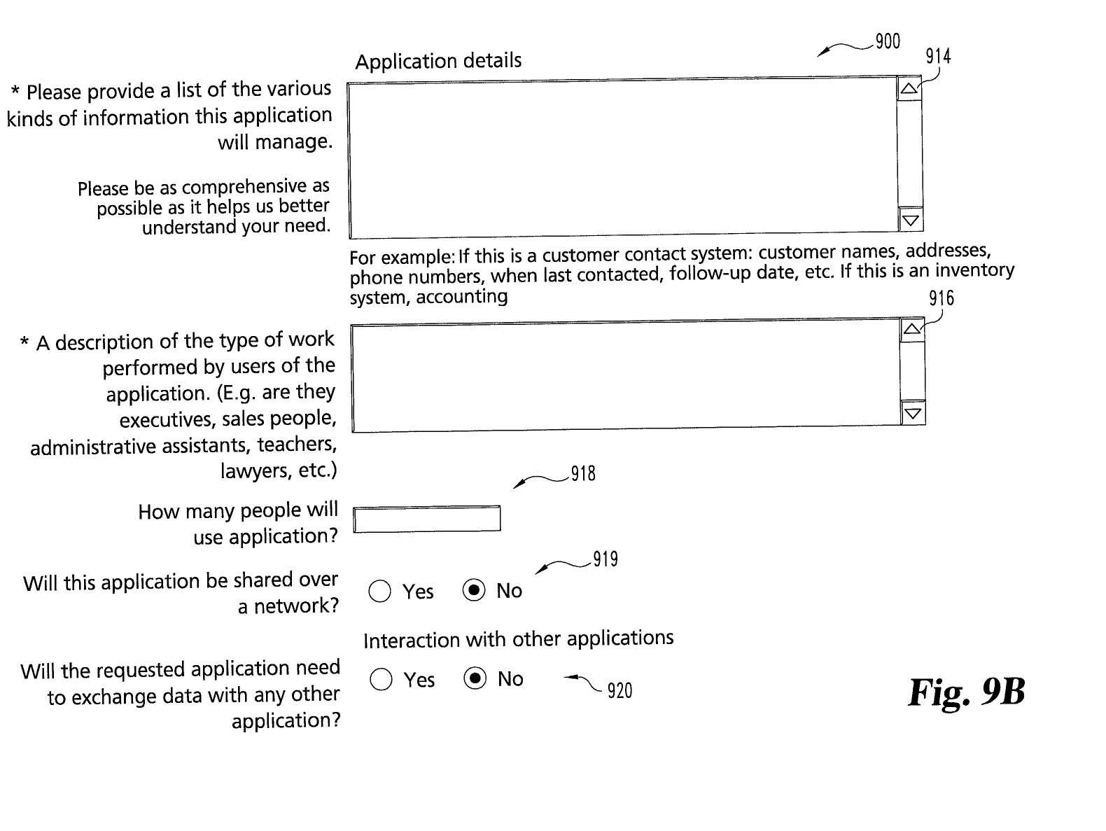

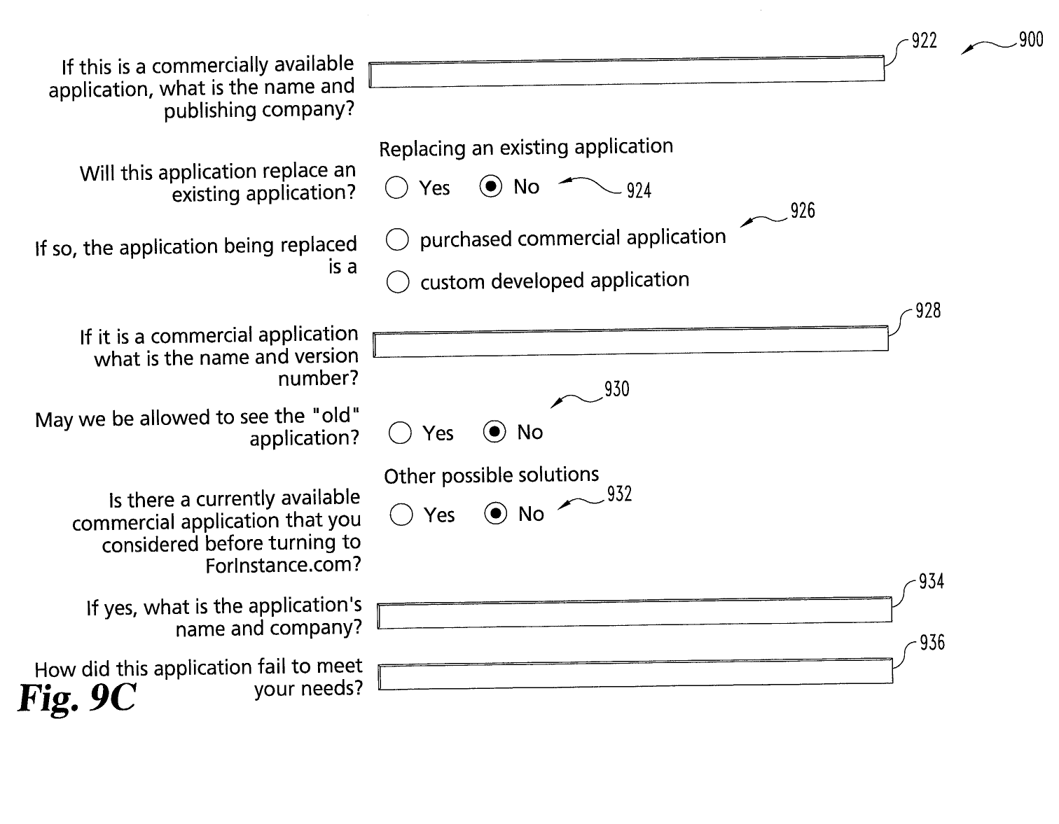

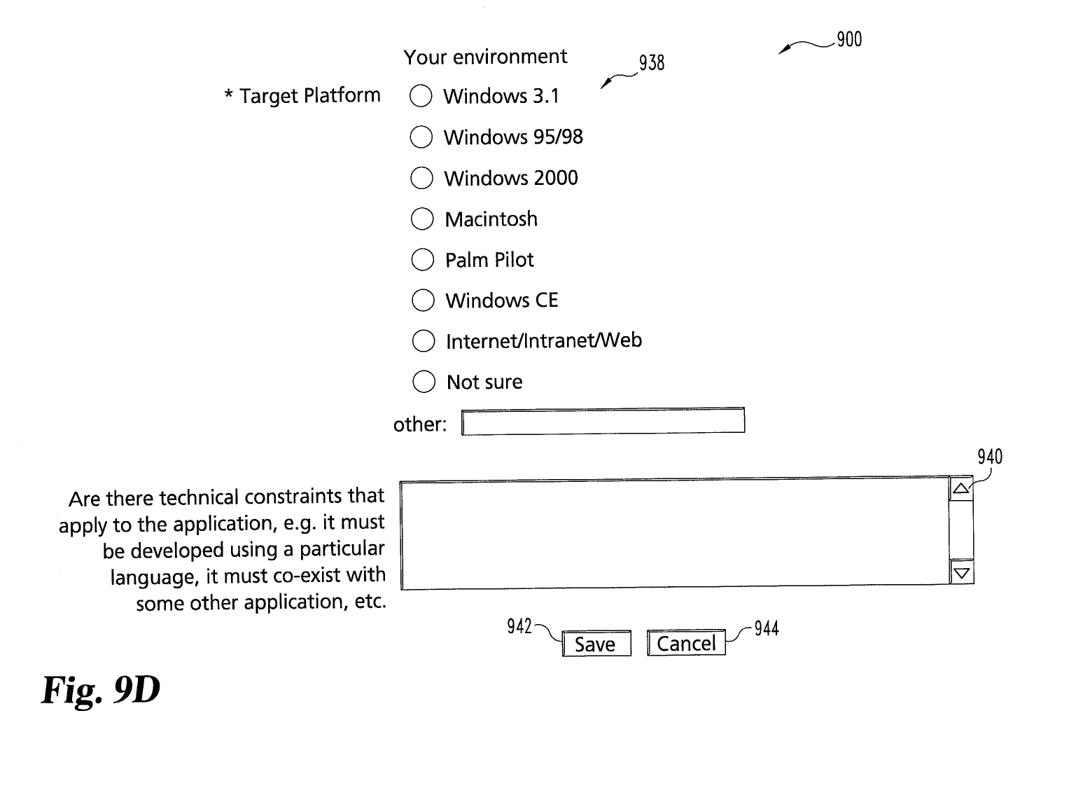

An example of a project request form 900 used by the administrator is illustrated in FIGS. 9A-D. A project request form for the customer only slightly differs from the project request form 900 of the administrator. In customer field 902, the administrator enters in the customer name. It should be appreciated that a project request form used by the customer does not necessarily need field 902, since the customer is identified once the customer logs into server 112. The telephone number of the contact person for the project is entered into telephone number field 904. With this telephone number, a project manager then is able to directly call the contact in order to ask additional questions regarding the project. The name and short description of the project are respectively entered into fields 906 and 908. The desired delivery date for the project is entered into field 910, and check boxes 912 are used to characterize the criticality of the delivery date. For example, the customer can specify that the delivery date is critical, important or negotiable depending on project priority. A detailed description of the information managed by the software application is entered into field 914 and a description of the type of work performed with the application is listed in field 916. The number of users for the software application is entered into field 918, and if the software application is expected to be shared over a network, this is indicated in check boxes 919. Radio button selectors 920 and field 922 are used to indicate if the software application will exchange data with another software application and the name of this software application. Field 924 is used to indicate if a prior software application is being replaced, and field 926 is used to indicate the type of software application being replaced. Field 928 and radio button selectors 930 respectively indicate the name of the replaced commercial software application and if the previous software application is available for review. Radio button selectors 932, field 934, and field 936 are used to indicate the names any possible alternative software applications and the reasons why these alternative applications failed to meet the needs of the customer. Environment entry section 938 is used to indicate the target platform environment, such as Windows. Any technical constraints, such as required programming languages, are entered into field 940. The administrator submits the project request form 900 by selecting save button 942 and cancels submission of form 900 by selecting cancel button 944.

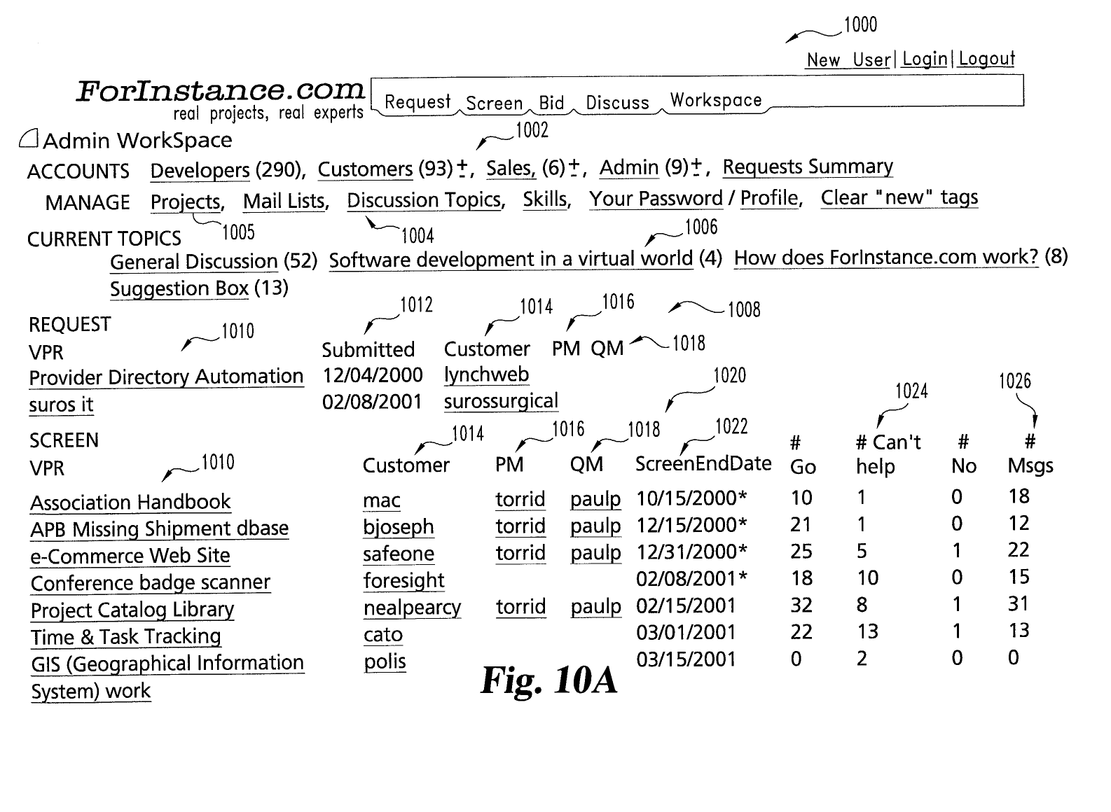

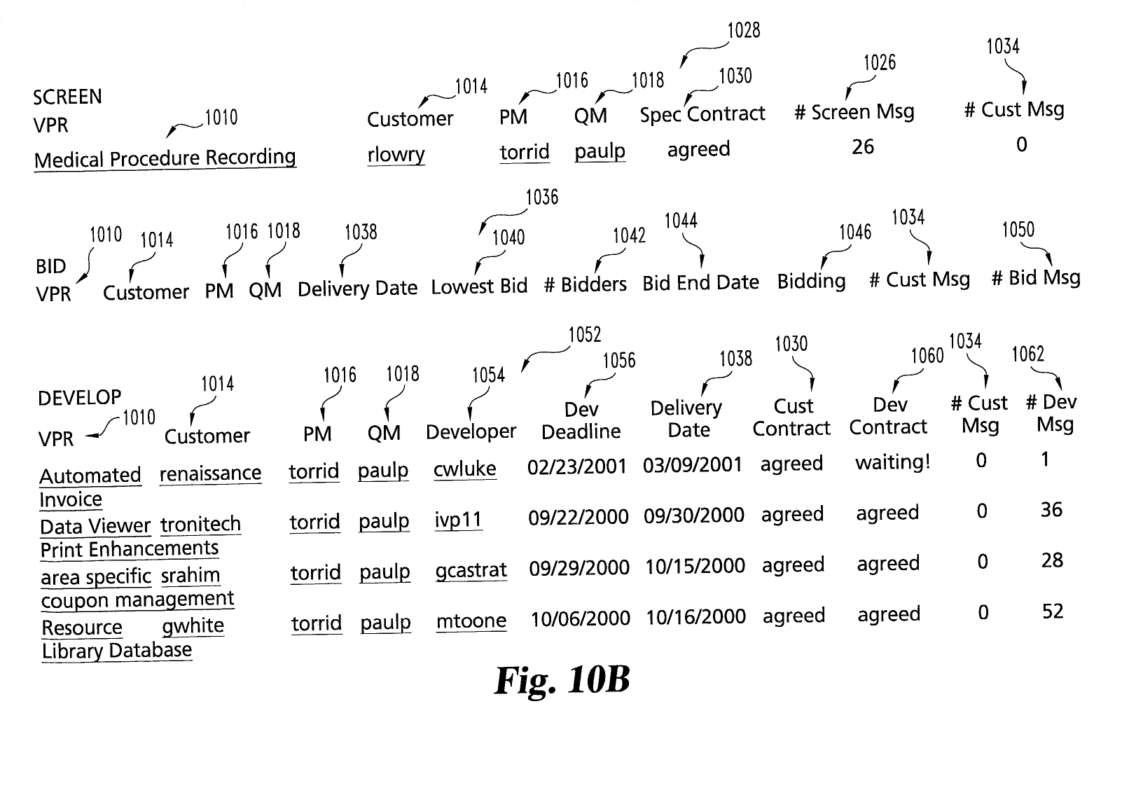

Upon receipt of the project request, the community server 112 automatically assigns a job number to the project request for tracking purposes and stores the project request in the project database 122. An administrator in stage 804 (FIG. 8) receives and acknowledges receipt of the submitted project request form 900. In one embodiment, the administrator acknowledges receipt of the project request form 900, and in another embodiment, server 112 automatically acknowledges receipt. The acknowledgement can come in many forms, such as a web page, an email, a fax or a telephone call. The administrator can be made aware of new projects in a number of ways. In one embodiment, an email is sent to the administrator computer 126 once the project request form 900 is submitted. In another embodiment, the administrator is made aware of new project requests by reviewing a dash board screen 1000, which is shown in FIGS. 10A-B. After logging in, the administrator selects the workspace button 318 (FIG. 3) in order to view screen 1000. With screen 1000, the administrator can manage the community server 112 and view project status summaries. By selecting an accounts management link 1002, the administrator can manage the accounts of customers, developers, salespersons, project managers, quality managers, and administrators. In addition, the administrator with accounts management link 1002 can manage project request summaries. By selecting a management link 1004, the administrator can manage projects, mailing lists, discussion topics, passwords/accounts, and developer profiles (skills). In order to assign managers to specific projects, the administrator selects link 1005 in the management links 1004. In addition, the administrator can clear “new” tags. Current discussions for particular topics can be viewed by selecting current topics links 1006.

A summary of submitted project requests is displayed in request summary section 1008. The request summary section 1008 includes project title fields 1010, date submitted fields 1012, customer fields 1014, project manager fields 1016, and quality manager fields 1018. The project title fields 1010 list the titles of project requests, and the date submitted fields 1012 show when the corresponding project request was submitted. Customer fields 1014 list the names (account name) of the customers submitting the projects. Fields 1016 and 1018 respectively display the project manager and quality manager assigned to the project.

Screening summary section 1020 provides a summary of projects that are being screened. The screening section 1020 includes the project title fields 1010, customer fields 1014, project manager fields 1016, quality manager fields 1018, screening end dates 1022, screening votes summary portion 1024, and number of screening messages fields 1026. The screening end dates 1022 specify when screening of the project is scheduled for completion. The screening votes summary portion 1024 summarizes vote tallies for screened projects, and fields 1026 summarize the number of screening messages for a particular project.

Specification summary section 1028 summarizes information about projects that are being specified. Section 1028 includes the project title fields 1010, customer fields 1014, project manager fields 1016, quality manager fields 1018, specification contract status fields 1030, number of screening messages fields 1026, and number of customer messages fields 1034. The specification contract status fields 1030 indicate if there is agreed specification contract. The number of customer messages fields 1034 indicates the number of customer messages that concern a particular project.

Bidding information is summarized in bidding summary section 1036. Bidding summary section 1036 includes the project title fields 1010, customer fields 1014, project manager fields 1016, quality manager fields 1018, scheduled delivery date fields 1038, lowest bid fields 1040, number of bidders fields 1042, bid end date fields 1044, developer bidding field 1046, number of customer messages fields 1034, and number of bidder messages fields 1050. The delivery date fields 1038 list when the project is scheduled to be delivered to the customer. The lowest bid fields 1040 show the current lowest bid for each project, and the number of bidder fields 1042 indicate the total number of bidders for each project. The bid end date fields 1044 list when bidding is scheduled for completion. The bidding developer with the lowest bid is listed in bidding field 1046, and the total number of messages from bidders is listed in fields 1050.

Information related to project development is summarized in development summary section 1052. Section 1052 includes the project title fields 1010, customer fields 1014, project manager fields 1016, quality manager fields 1018, developer fields 1054, development deadline fields 1056, scheduled delivery date fields 1038, specification contract status fields 1030, development contract status fields 1060, number of customer messages fields 1034, and number developer messages fields 1062. The developer for each project is listed in developer fields 1054, and the development deadlines are listed in the development deadline fields 1056. The developer contract status fields 1060 list the current status of the developer contract (waiting on agreement or agreed). The number of messages from developers of each project are listed in fields 1062. At anytime after a project request has been submitted, the administrator can assign (or reassign) the project manager and quality manager to the project.

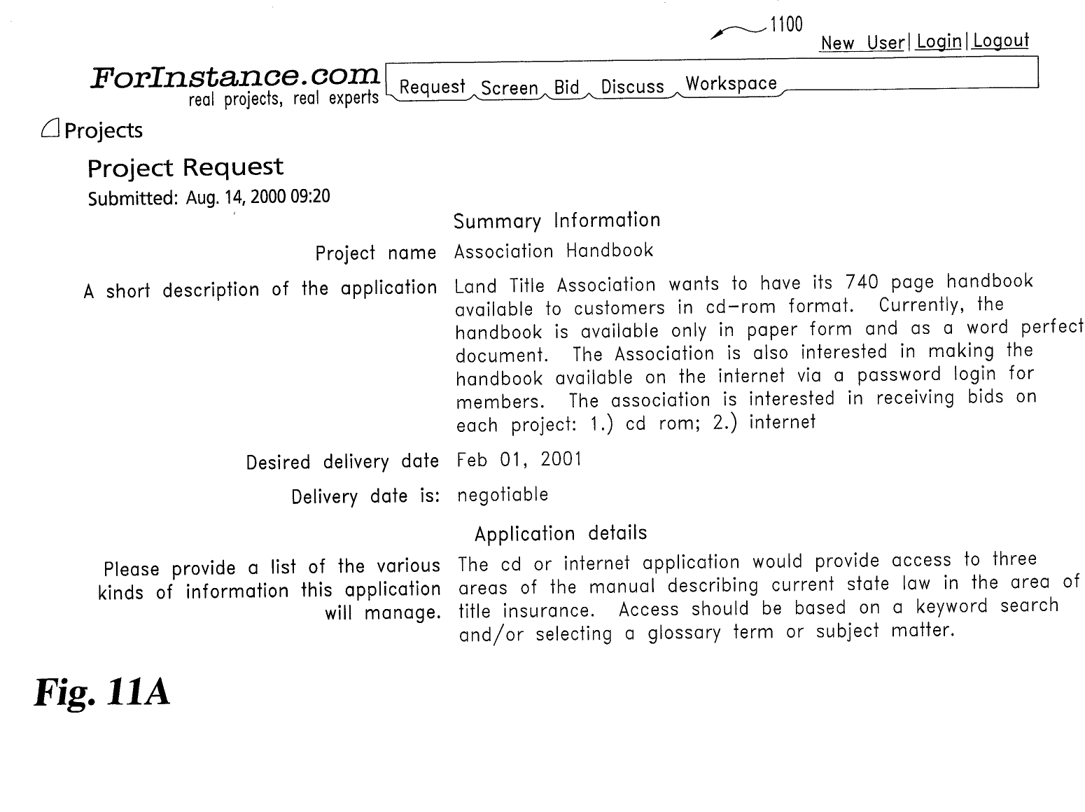

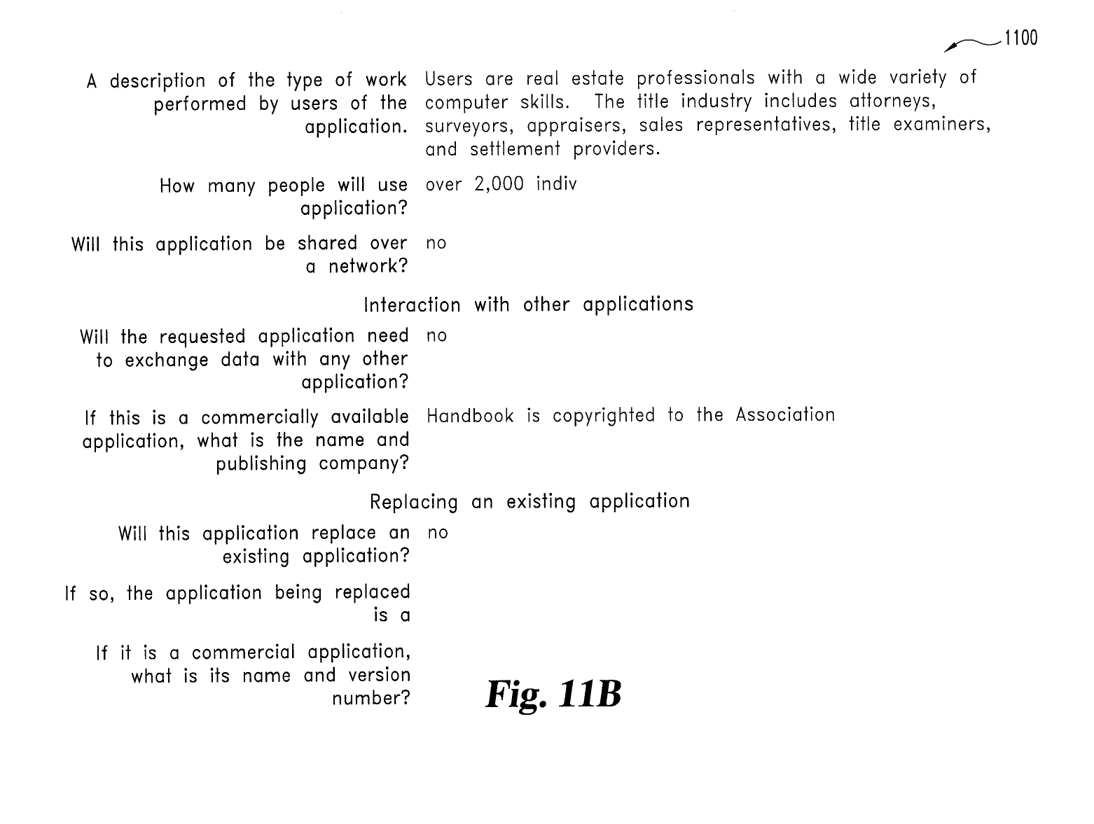

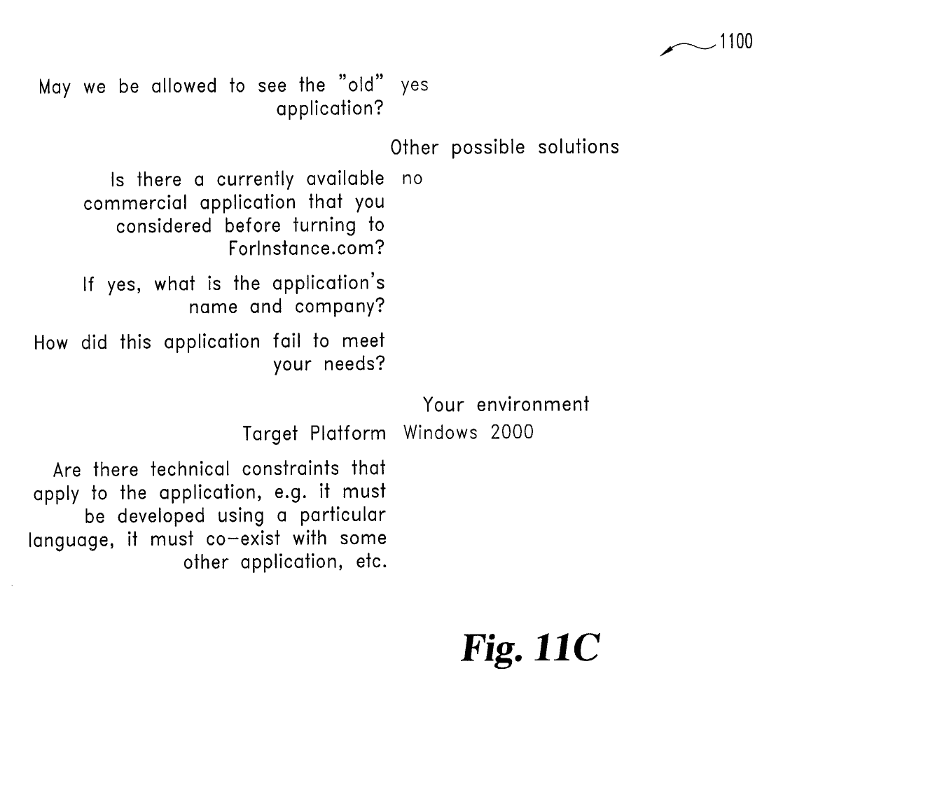

Through the dashboard screen 1000, the administrator can review submitted project requests in section 1008. To view a particular request, the administrator selects the project title field 1010 for the particular project. An example of a project request display screen 1100 is illustrated in FIGS. 11A-C. As shown, the project request display screen contains the project information that was entered by the customer in the project request form 900. In stage 806 (FIG. 8), the administrator (and/or newly assigned project manager) reviews the history of the customer submitting the project request. The customer history includes a record of past projects from the customer, and these records are stored in the project database 122. In one form, the administrator reviews the customer history stored in database 122 in order to use as one basis for determining if the requested project is suitable. The customer history can also include customer-billing information. In another form, the project manager reviews the billing history of the customer and past customer projects in order to determine if the submitted project is worthwhile.

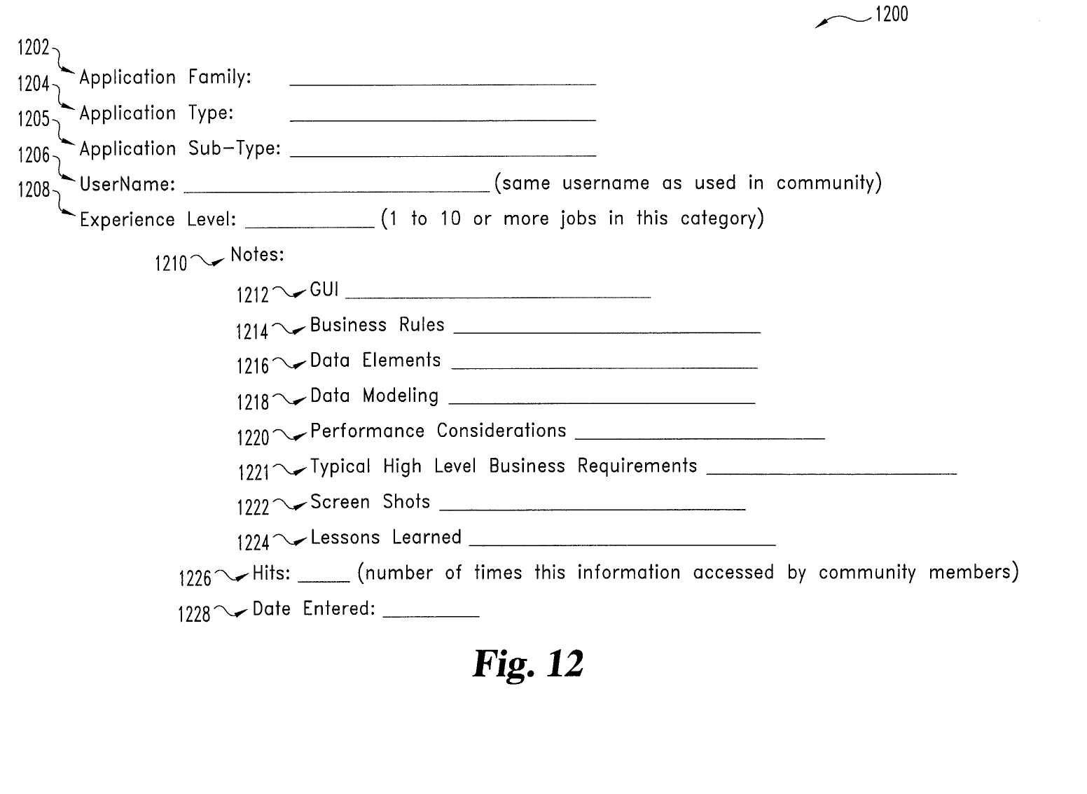

In stage 808, the administrator determines whether the requested project matches previous project types. The project database 122 maintains job type templates that categorize previous types of projects, and these templates contain information learned from the previous projects. An example of a job type template 1200 is illustrated in FIG. 12. The job type template 1200 is maintained by the project manager throughout the development process. Application family field 1202 is used to enter the general software application category. Application type field 1204 and application subtype field 1205 further categorize the project. The name of the developer for the project is entered into user name field 1206, and the experience level of the developer is entered into field 1208. Notes about a particular project are entered into notes section 1210. A graphical user interface (GUI) for the software application is recorded in field 1212, and business rules for the project are recorded in field 1214. Data elements for the software application are entered into field 1216, and any data modeling information is entered into field 1218. Any performance considerations during development are entered into field 1220, and any business requirements for the project are entered into field 1221. The file locations of any screen shots for the developed software application are entered into field 1222. The manager can also enter any lessons learned from the project into field 1224. The number of times the job type template 1200 is reviewed (hit) is automatically maintained by the server 112 and is displayed in field 1226. The form entry date is recorded in field 1228. The information contained in the job type template 1200 can be used to reduce development time.

In one form, server 112 automatically compares the submitted project request form 900 with the job type templates 1200 stored in database 122 in order to generate a list of possible job types for the submitted project. The administrator can review the retrieved job type templates 1200 to determine if any of the past projects can be used in developing the current project. In another form, the project manager manually reviews the job type templates 1200 stored in database 122 in order to find matching project types. If a matching project type is found, the project manager in stage 810 can then use the stored job type template 1200 in estimating project costs and for providing guidance during project development.

In stage 812 (FIG. 8), the administrator posts the project on server 112 so that the community of developers can review the project request. Having the developers involved early in the screening phase reduces the risk that unpopular and problematic projects will be accepted. To provide this motivation, developers are given incentives to review project requests. Developers receive participation points for screening projects, and these participation points are later used as one factor in adjusting bids submitted by developers. Generally, the higher participation points a developer receives causes the bid amount to be proportionally lowered, which in turn increases the chance that the developer will be awarded the project. In addition, the screening phase allows developers to develop and express an interest in a particular project. This in turn increases the chance that developers will be available to develop the project.

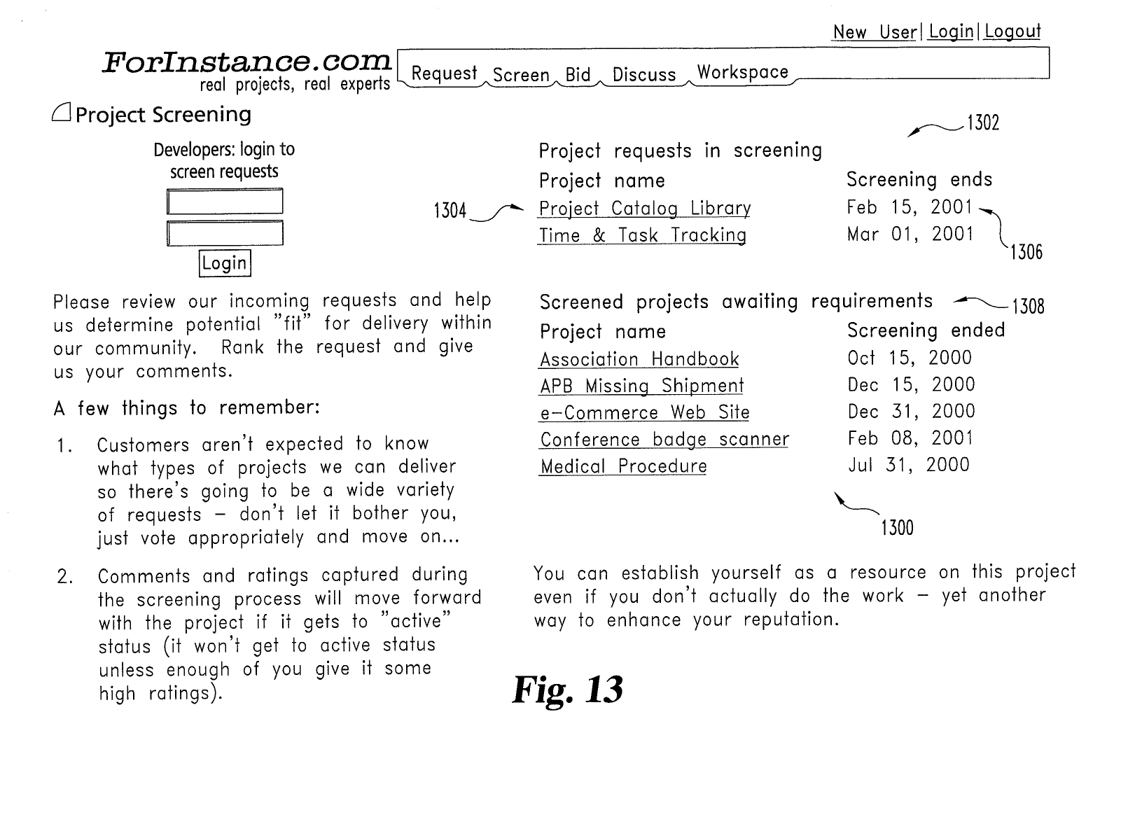

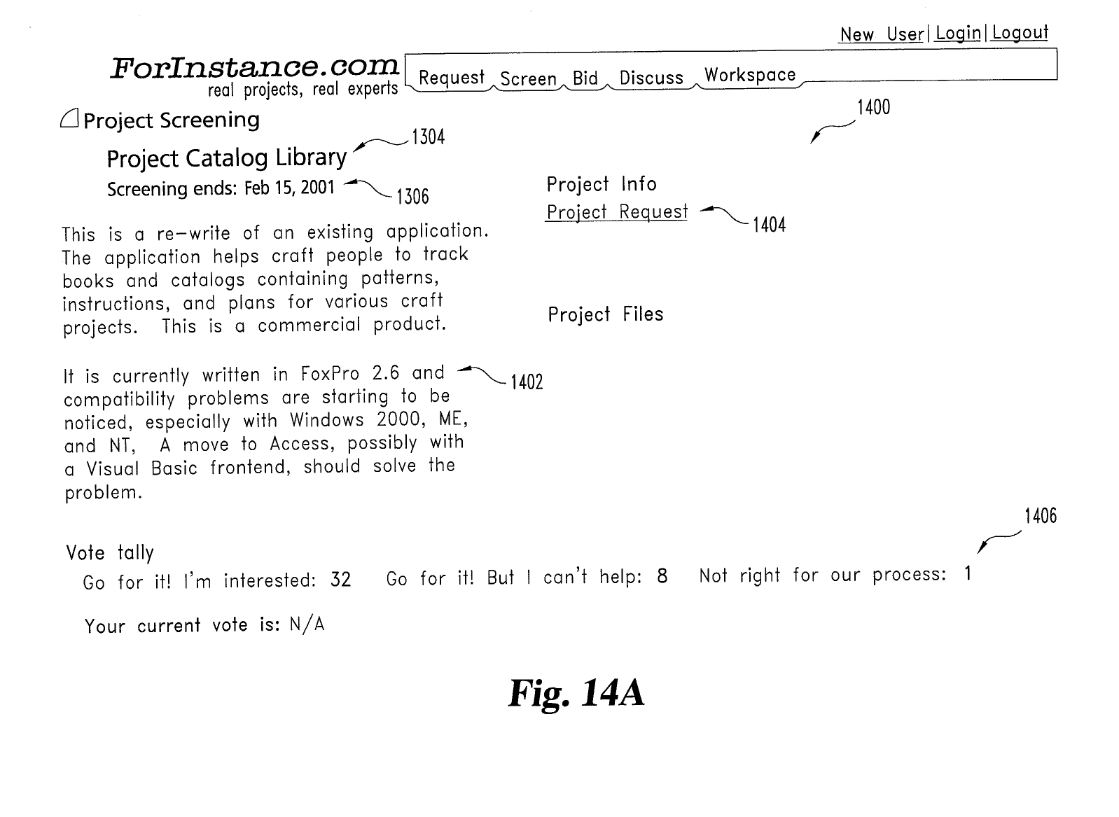

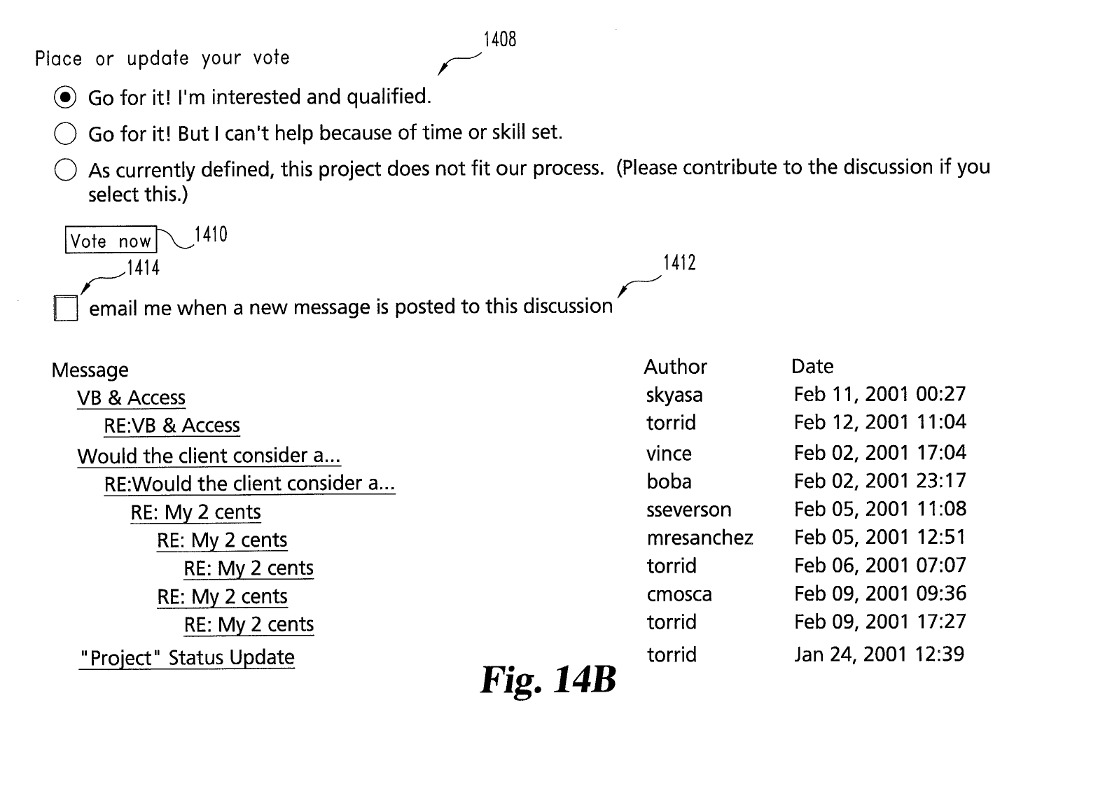

In order to screen projects, the developer initially selects the screen button 310, which is shown in FIG. 3. A project list display 1300, which is illustrated in FIG. 13, is then displayed. Projects available for screening are listed in screening area 1302. Screening area 1302 contains project names 1304 and screening end dates 1306 that indicate when screening is scheduled for completion. In one form, the screening end dates are set from 3-5 days from the request submission date. A screened projects awaiting requirements area 1308 of display 1300 lists the projects that have been screened but do not have specified requirements. To screen a project, a developer selects the particular project name 1304, and then a project screening and discussion screen 1400 is displayed for the selected project. Screen 1400 shows the project name (title) 1304 and the project end date 1306. A summary of the project is also displayed. The developer can view the project request by selecting a view project request link 1404. The public (unregistered users) can also view projects in order to determine if they would want to participate in developing projects. Both the developers and the public are unaware of the customer name submitting the project. This reduces the risk that a developer will try to circumvent the system by directly soliciting the customer. A current vote tally section 1406 lists the current vote tallies regarding the particular project. The individual developer can vote on the particular project in voting section 1408. As shown, the developer can vote a number of ways including: “Go for it! I'm interested and qualified”; “Go for it! But I can't help because of time or skill set”; or “As currently defined this project does not fit our process.” The developer submits a single vote by selecting a vote button 1410, and the submitted vote is then recorded in the project database 122. Each developer is only allowed one vote per project, and any subsequent vote over-writes an earlier vote. The project can be discussed in a discussion section 1412 of screen 1400. Developers can post messages, ask questions, and chat about the project being screened. By selecting alert check box 1414, developers can choose to be alerted about newly posted messages. Voting by the developer community is a valuable tool for evaluating projects. Positive voting results generally increase the chance that developers will be available to develop the project.

After reviewing the project request, the customer history, input from the developers, job templates and other information, the administrator in stage 814 (FIG. 8) decides whether to accept the project. If the project is not accepted, the administrator in stage 816 notifies the customer that the project was not accepted. A project can be unacceptable for a number of reasons including cost and negative feedback from the developer community. The customer can be notified via email, telephone, fax, regular mail and in other generally known manners. If the administrator accepts the project, the project manager and quality manager are then assigned. It should be appreciated that these managers can be assigned earlier to take ownership responsibilities in the project. In stage 818, the project manager estimates the time and material cost for developing the specification and prototype for the project. The project manager can base this cost on costs estimates recorded in the job type templates 1200 (when available). After the estimate is completed, the project manager sends the customer a time and material (T&M) contract (specification contract) for developing the specification and prototype to the customer. In one form, the contract is sent via email, and in another form, the contract is posted to a website that is only accessible by the requesting customer. It should be understood that the specification contract can be sent in other manners generally known by those skilled in the art.

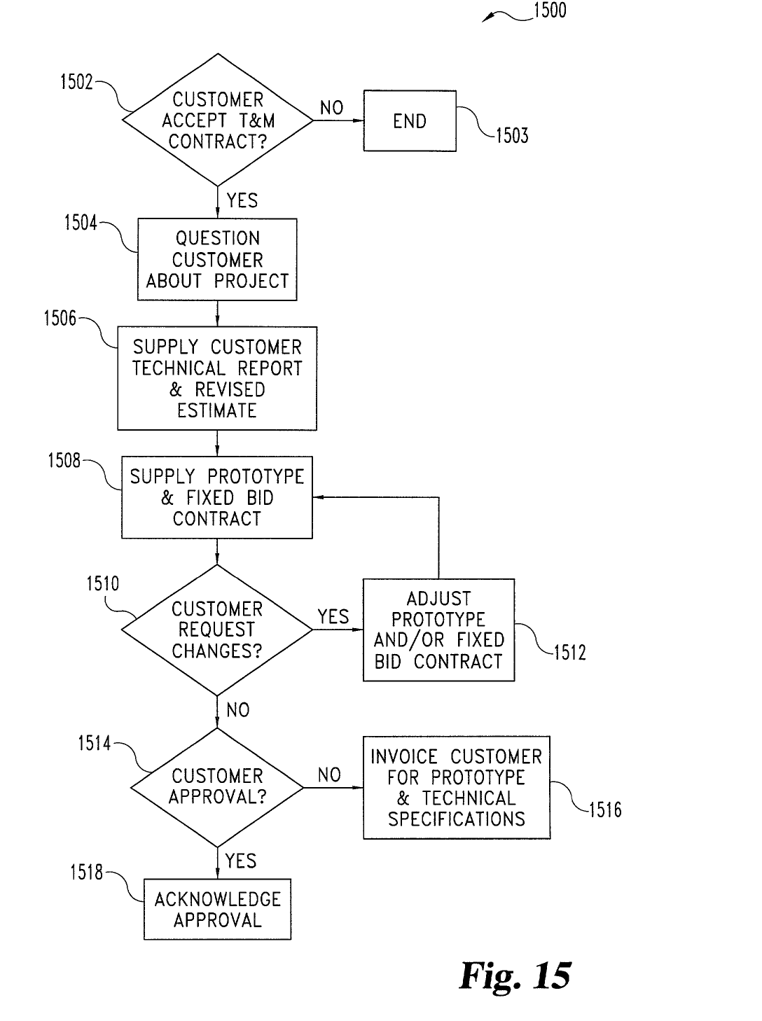

After the administrator accepts the project, the project enters into a project definition phase 206 (FIG. 2). A flowchart 1500, which is shown in FIG. 15, illustrates the definition phase 206 according to one form of the present invention. In stage 1502, the customer either accepts or rejects the specification contract. If the customer rejects the specification contract, the parties can negotiate new terms or terminate negotiations in stage 1503. If the customer accepts, the project manager in stage 1504 interviews the customer about the project in order to fully develop the technical specifications and determine a cost estimate for a fixed contract for the project. The project manager can generate interview questions based on information contained from the job type template 1200 and the project request. The interview can occur purely over the computer network 106, over telephone, face-to-face, through correspondence and/or in other manners. Multiple interviews can occur in order to fully define the scope of the project and any technical details.

In stage 1506, the project manager sends the customer a technical specification (details) report and revised prototype estimate for the project. In one form, the project manager sends the customer an email that contains the URL address for a web page that contains the technical specification report and the revised estimate. For example, the email can state the following:

Your application requirements, technical details, and a revised estimate to prototype your work are posted at http:// . . . job#. Please take a look and confirm your details.

Only the customer that submitted the project request is granted privileges to access this web page. The customer can review and send comments to the project manager. From comments these, the project manager can refine the technical specification. After the customer reviews the technical specification, the project manager and the operations group develop a prototype. In addition, the project manager drafts a fixed bid contract for the cost of the entire project. Once the prototype and the fixed bid contract are completed, the project manager supplies the fixed bid contract and prototype to the customer for review in stage 1508. In one form, the project manager sends the customer an email containing the URL address for a website that displays the prototype and the fixed bid contract. The listed web sites are secured to prevent unauthorized access by others. For example, such an email can state the following:

You can look at your prototype at http:// . . . prototype/job#. We have also prepared a guaranteed quote for actually developing your application. You can find it at http:// . . . /quote/job#. Please review your prototype and quote and {instructions on following up on the project}. If you choose not to use us to build your application, you will be billed $xx.xx for the prototype and requirements work. If you decide to build the application, we will not bill you for this work.

If the customer requires changes to the prototype and/or the fixed bid contract in stage 1510, the project manager then in stage 1512 makes the appropriate changes. Please note that any changes to the prototype may change the project cost supplied in the fixed bid contract. After any revisions, a revised prototype and fixed bid contract are supplied to the customer (stage 1510). If the customer requires no additional changes, the customer can finally approve or disapprove the fixed bid contract in stage 1514. If the customer does not accept the fixed bid contract, the customer is invoiced for the prototype and technical specification work in stage 1516. This allows the administrator and project manager to recoup the prototype and specification costs. Upon approval of the fixed bid contract, the project manager in stage 1518 acknowledges this approval and sends the customer additional questions regarding the project. The customer at this time is not billed for the prototype and technical specification work, because this cost is factored into the fixed bid contract. Once the customer signs the contract and pays the down payment for the project, the project manager is then committed to deliver the project. This contractual obligation to the customer motivates the project manager to have the project succeed.

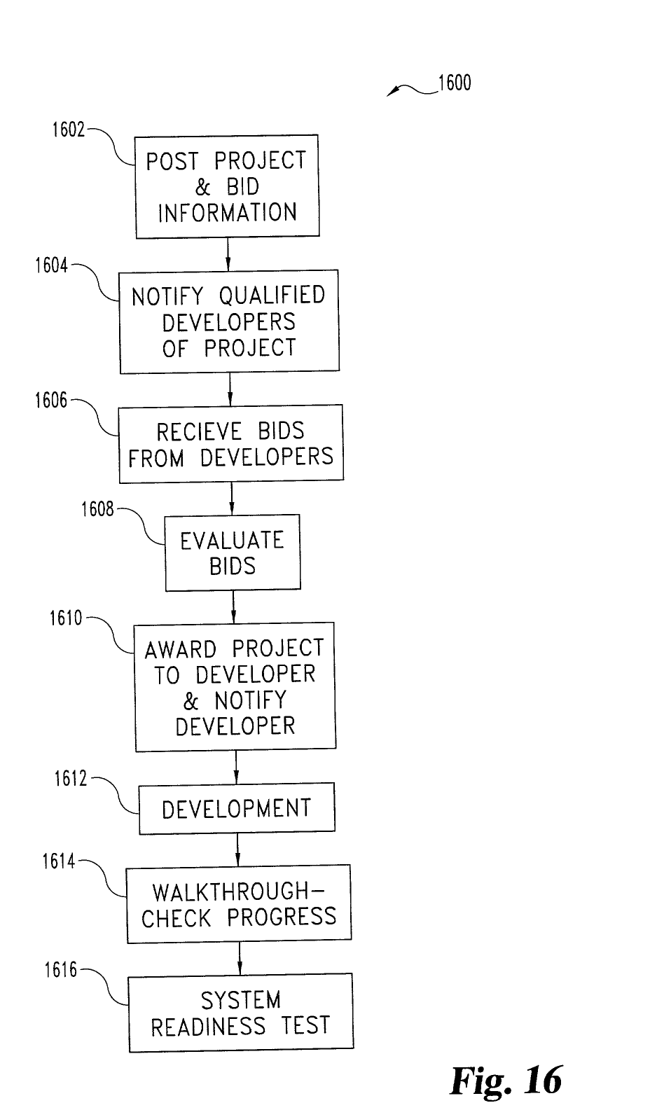

After the bidder accepts the fixed bid contract, the project enters a construction phase 208 (FIG. 2). Flowchart 1600, which is shown in FIG. 16, illustrates the construction phase 208 according to one form of the present invention. In stage 1602, the operations group posts the project on server 112. When the project is posted, additional information regarding the bidding process is also posted. This information includes a bid ceiling, which limits the maximum bid, and a bid ending date, which is the scheduled closing date for bidding. A minimum bid increment for the bidding process is also posted. The bid increment is the minimal amount a bid must differ from a previous bid.

The operations group and the project managers can research the project database 122 and developer profiles 700 to find qualified developers for the project. In stage 1604, the qualified developers are contacted so as to promote the project to them. In form, an email is sent to the qualified developers, which describes the project and contains a URL link that links to a bidding web page for the particular project. For example, the email can state the following:

A new job has been posted, and technical details are posted at http:// . . . /req&spec/job#. All bids are considered final. You can bid additional times to lower your bid. We will stop accepting bids at XX:XX:XX est. This job must be delivered by Mon, DD, YYYY.

Developers can also initiate the bidding process by selecting the bid button 314 on screen 300 (FIG. 3). As shown in FIG. 17, a bid list screen 1700 is then displayed that lists projects available for bidding and recently awarded projects. Screen 1700 contains section 1702, which lists the projects that available for bidding. Section 1702 contains project name(s) 1704, delivery date(s) 1706, number of bidders 1708, and a bidding end date 1710. Section 1712 lists the bidding information for projects that are already being developed.

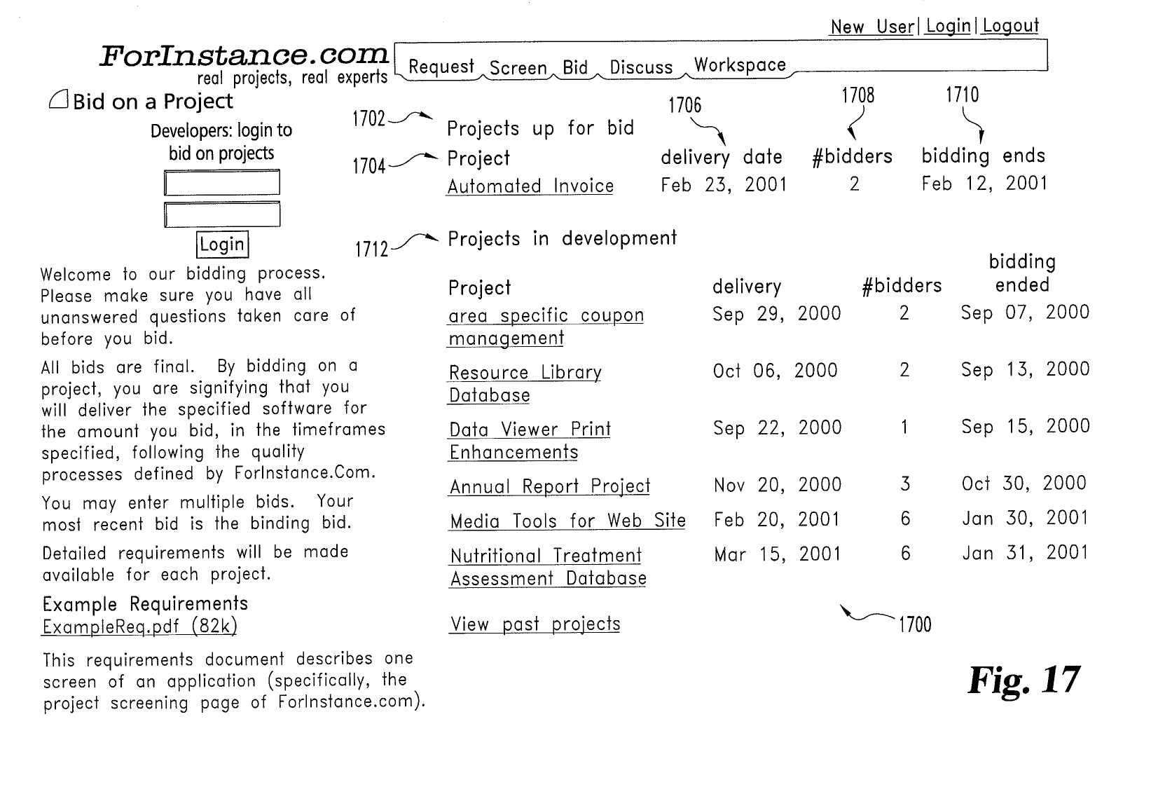

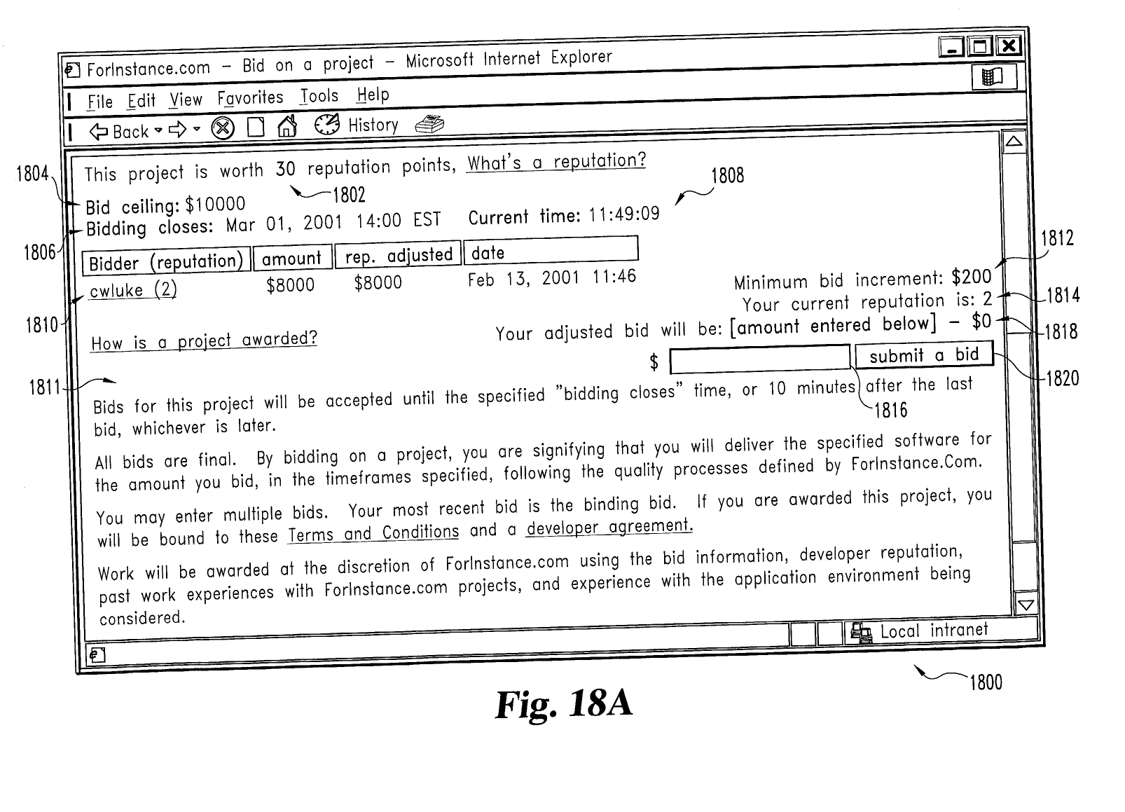

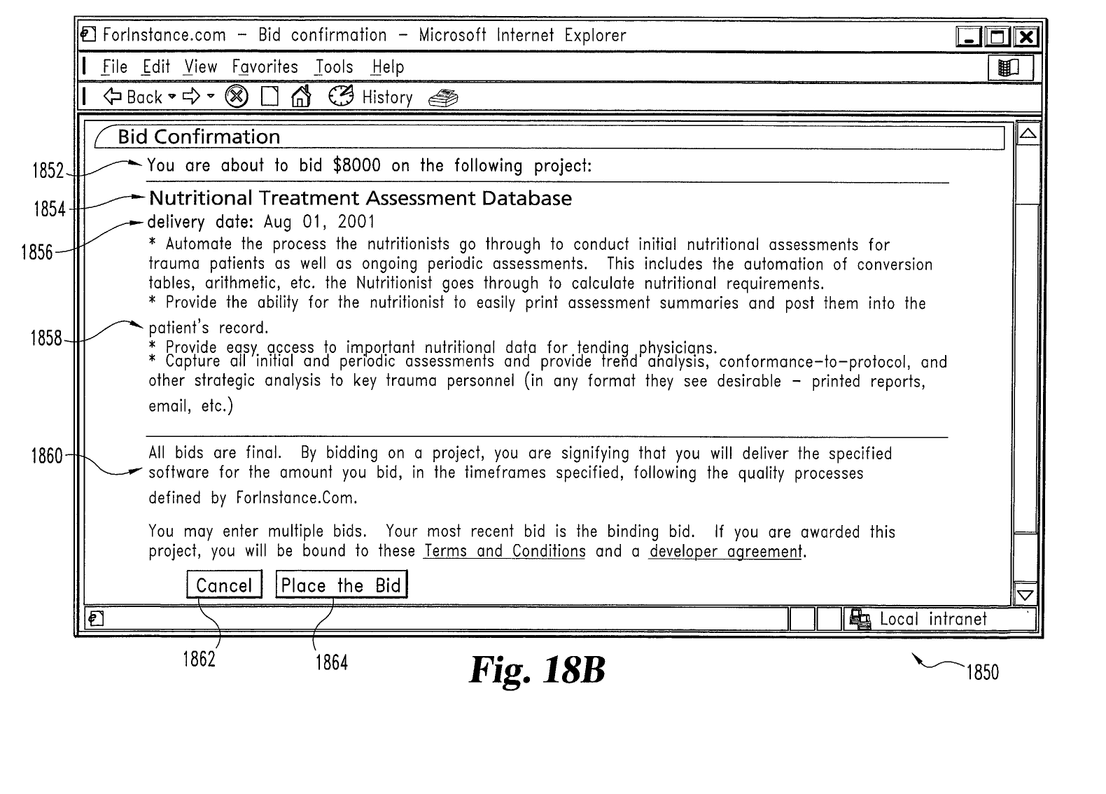

Once a developer selects a project, a bidding screen 1800 (FIG. 18A) is then displayed. Screen 1800 lists base reputation points 1802 that can be earned. Earned base reputation points 1802 is another factor used to adjust submitted bids, and the base reputation points 1802 provide an incentive for developers to successfully complete projects. By successfully completing the project, the developer can add the base reputation points to the overall reputation score of the developer. Bid ceiling 1804 lists the maximum bid allowed, and bid closing date 1806 states when bidding is scheduled for completion. Generally, the bid ceiling 1804 is less than the quoted price in the fixed bid so that a profit can be generated from the project. A current time field 1808 is used to show the current time so that there is no confusion as to the bid closing date 1806. A bidder section 1810 lists the bidders for the project along with their respective earned reputation points, submitted bids, adjusted bids, and submission dates. The submitted bids are adjusted based on the reputation score earned by the individual developer. The overall reputation score includes the earned base reputation points and the participation points of the developer. Bid instructions 1811 disclose how the bids are placed and how the bids are awarded. Screen 1800 further includes a minimum bid increment 1812 for the project and the current reputation score 1814 of the developer. The developer enters a bid into a bid field 1816. As the bid is entered, adjusted bid amount field 1820 automatically displays the adjusted bid for the developer. The developer submits the bid by selecting a submit button 1820.

In response to this submission, the community server 112 sends to the developer a bid confirmation screen 1850 (FIG. 18B). It should be appreciated that the bid confirmation screen 1850 can be incorporated into screen 1800. The bid amount of the developer is shown in field 1852. The title of the project, delivery date and project summary are respectively shown in areas 1854, 1856 and 1858. Terms and conditions for bidding are listed in area 1860. The developer cancels the bid by selecting a cancel button 1862, and the developer confirms the bid by selecting a place button 1864. In another form, the bid is submitted via email.

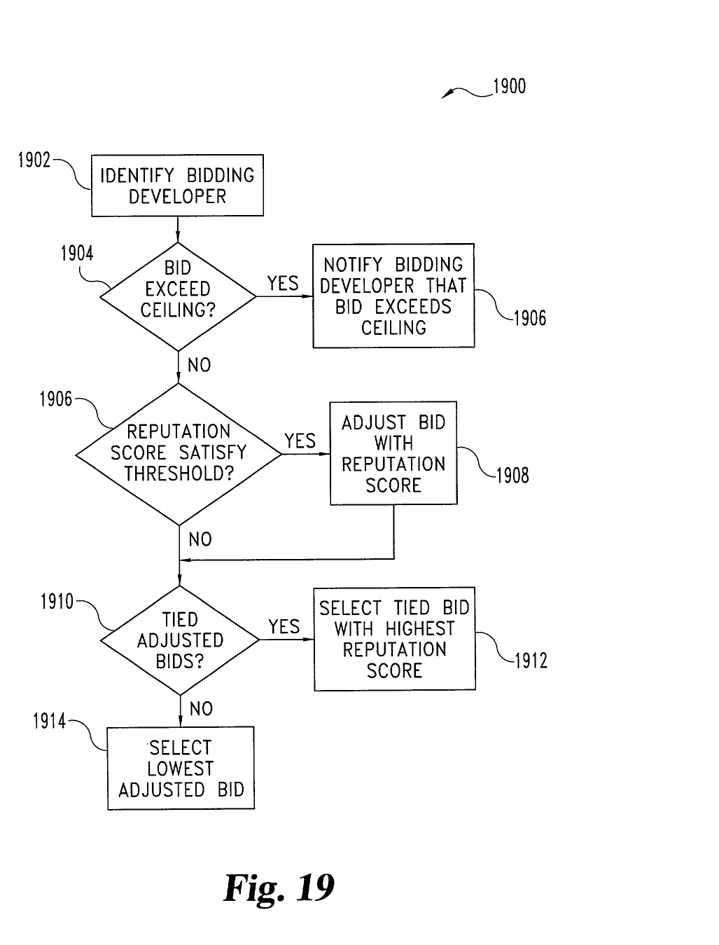

In stage 1606 (FIG. 16), bids from competing developers are received, and the bids are evaluated in stage 1608. In one form, sever 112 automatically evaluates the bids. In another form, the project manager evaluates the bids. Flowchart 1900, which is shown in FIG. 19, illustrates a method for evaluating bids according to one form of the present invention. In stage 1902, the developer registration information that is stored in the project database 122 is used to identify the bidding developer. It should be appreciated that the developers can also be identified by having their names on the submitted bids. If the bid submitted by the developer exceeds the bid ceiling in stage 1904, the developer in stage 1906 is notified that the bid exceeds the bid limit. For example, the bid confirmation screen 1850 can state that the bid exceeds the bid ceiling. If the developer submits multiple bids, only the most recent bid is reviewed. Along with the profile information for the developer (FIGS. 7A-B), the earned reputation points for each developer is stored in the project database 122. All members of the developer community have a reputation score assigned to them. These reputation scores are a way of factoring in the reputation of the developer when the bids are submitted. The reputation score also motivates developers to participate in the developer community and to successfully complete projects. The reputation score can incorporate factors such as the quality of previous work from the developer and delivery timeliness. Upon registration with the community, each developer is automatically assigned a reputation score of zero (0). Developers can increase their reputation score by taking an active role in the community. The overall reputation score for a developer equals the sum of the base reputation points earned and participation points earned. Equation 1, below, summarizes how reputation scores are calculated according to one form of the present invention.

Reputation Score=Base Reputation Points+Participation Points (1)

Developers earn base reputation points by delivering projects on time and by providing quality work. The developer earns participation points by taking an active role in the developer community. There are several ways developers can impact their reputation scores. Table 1 (below) is an exemplary list of how developers can affect their reputation scores. It should be understood that other factors can be used to modify reputation scores.

TABLE 1

| ACTION | POINTS IMPACT |
|---|---|
| Application delivered and accepted on | Affects base reputation points up to 30 |
| time. | points per application. |
| Failing to deliver an application | Affects base reputation points up to |
| | −45 points |
| | = (−1.5 × project point value) |
| Screening Projects | Affects participation points. Total |
| | participation points cannot go below 0 or |
| | exceed 20 points. |
| Developer votes | +1 participation point/week |
| Developer fails to vote | −1 participation point/week |
| Abusing any information in the community | Reputation score reset to zero or |
| including attempts to send unsolicited | banishment from the community |
| emails, marketing of services to others, etc. | |

In one form of the present invention, individual developers submit bids. In another form, teams of developers submit bids and an aggregate reputation score of the team members is used to adjust the bid. In stage 1906, server 112 determines whether the developer has a reputation score that satisfies a reputation threshold limit or not. If the reputation score of the developer satisfies the threshold limit, the bid of the developer is adjusted in stage 1908. In one form, the reputation threshold limit is ten (10) points. Bids from developers with reputation scores less than ten (10) are not adjusted, and any bids reputation scores greater than or equal to ten (10) are adjusted. It should be appreciated the threshold limit can vary depending on the bidding environment. Equation 2 (below) is an example of an equation that can be used to adjust the bid.

Reputation Adjusted Bid=Actual Bid−(Bid Modifier×Bid Increment) (2)

The actual bid is the bid submitted by the developer. The bid increment is the minimum amount a bid must differ from a prior bid. Bid increments are generally increased for larger bid ceilings. This allows the bid increment to compensate for relatively large project so that the reputation score of the developer is properly factored into the adjusted bid. The bid modifier is based on the reputation score of the particular developer. An example of this relationship is shown in Table 2 below.

TABLE 2

| REPUTATION SCORE | BID MODIFIER |
|---|---|
| 0 to 20 | 0 |
| 21 to 80 | 1 |
| 81 to 200 | 2 |
| 201 and above | 3 |

For example, with a bid increment of one-hundred-dollars ($100), a bid of $4,800 from a developer with a reputation score of five (5) has a reputation adjusted bid of $4,800; while a developer with a reputation score of 110 and a bid of $4,600 has a reputation adjusted bid of $4,400 (using the bid modifiers of Table 2). If the adjusted bids are tied in stage 1910 (FIG. 19), then the tied selected bid with the highest reputation score is accepted in stage 1912. Otherwise, the lowest adjusted bid is accepted in stage 1914.

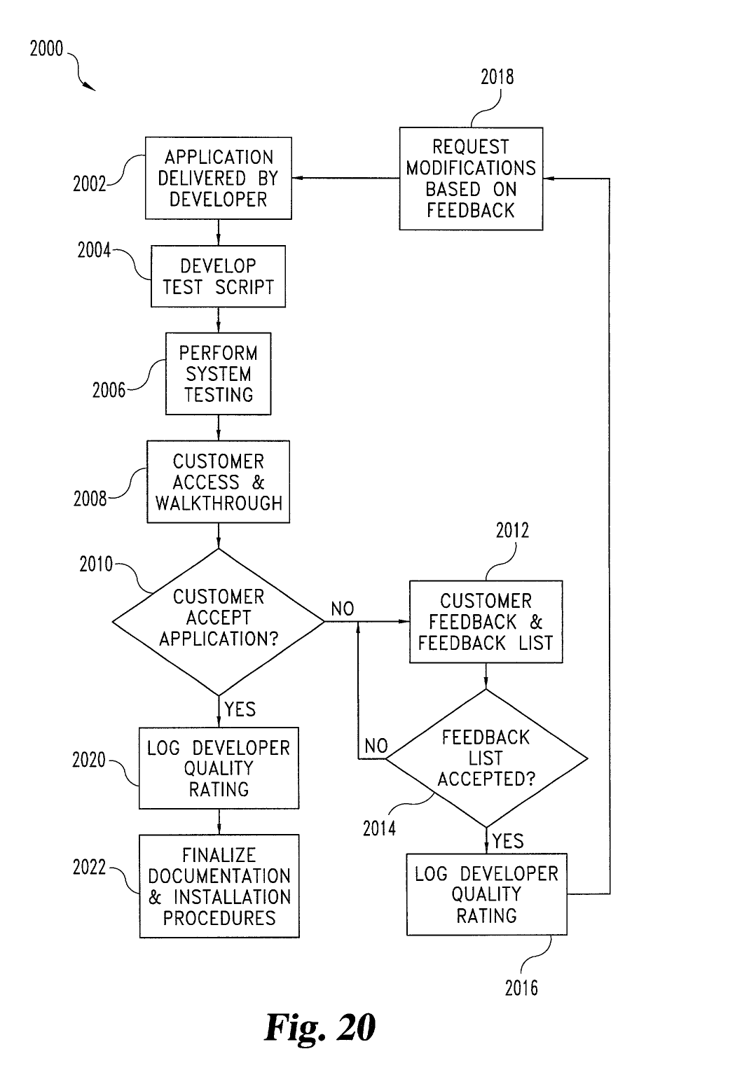

Before the project is awarded, the bidding developer must provide evidence that the developer is qualified for the project. The project manager can request the bidding developers to update their profiles. Developers can update their profile information in the developer profile form 700 (FIGS. 7A-B). To access form 700, a developer initially selects the workspace button 318 (FIG. 3) in order to view a developer workspace screen 2200, which is shown in FIG. 20. Screen 2200 shows a username 2202 and a current reputation score 2204 for the developer. Earned base reputation points 2206 and participation points 2208 are also shown. A reputation history of the developer can be reviewed by selecting link 2210. The developer profile form 700 can be accessed by selecting an edit profile link 2212. Developer contact and password information can be edited by selecting links 2214 and 2216, respectively. Project summaries (status) for the developer are displayed in a projects area 2218 of the form 2200. In addition to requiring an updated developer profile, the project manager can require that the bidding developer submit a work plan for the project. The work plan can include development schedules and milestones, which are later used to check development progress.

If a developer fails to provide the proper qualifications, then the bid of the developer is ignored. The project is then awarded in stage 1610 (FIG. 16) to the developer with the proper qualifications and the best reputation adjusted bid, and the winning developer is notified. In one form, an email is sent to the winning developer. It should be appreciated that the developer can be contacted through other channels, such as through faxing and/or telephone calls. For example, the message awarding the project to the developer can state the following:

Congratulations! You have been awarded the bid for job##. Upon customer acceptance of the work you will be paid $xx.xx (bid amount). Based on your work history with us, a quality walkthrough is required every x days. Please contact John Smith at 123-435-1234 (jsmith@jsmith.com), who is the manager for this project. This job must be delivered by Mon, DD, YYYY.

After being awarded the project, the developer begins development of the project in stage 1612 (FIG. 16). The developer can access the community server 112 in order to access the specification and requirements for the project. The developer can also use server 112 in order to communicate with the project and quality managers. Through server 112, developers can chat, post questions, and download open source components for projects. Based on past performance, the developer is periodically required to walk through the status of the project with the program manager in stage 1614. The program manager, quality manager or server 112 can set the intervals for checking the progress of the project. In one form, the project manager bases the intervals on the milestones contained in the work plan submitted by the developer. In another form, these intervals are based on the developer work history, which is stored in the project database 122. During stage 1614, the quality manager and developer discuss the project and the progress of the project is compared to a unit test checklist that includes the requirements and specifications for the project. The quality manager also prepares a system readiness checklist in order to ensure that the software application being developed conforms to the defined requirements and specifications. Once the developer considers the project complete, the quality manager in stage 1616 performs a system readiness test on the software application. The quality manager compares the operation of the software application with the system readiness checklist in order to decide if the software is ready to be released to the customer. If the software application is not ready, the developer is then asked to make the appropriate changes. Once the software application passes the system readiness checklist, the application is released for review by the customer.

After the quality manager releases the software application, a formal testing phase 210 (FIG. 2) begins. Flowchart 2000, which is shown in FIG. 20, illustrates the formal testing phase according to one form of the present invention. In stage 2002, the developer delivers the software application for formal testing. In one form, the developer transfers the program from the developer computer 102 to the project server 136. The project server 136 is kept separate from the community server 112 for a number of reasons. One reason is to reduce the workload on the community server 112 and isolate the community server 112 from any crashes during formal testing. Another reason is that some developed software applications need run in a variety of specialized operating environments. Although one project server 136 is shown in FIG. 1, it should be appreciated that multiple project servers 136 can be used for each type of platform/operating system. In another form, the testing is performed on the community server 112, and in a further form, the testing is conducted on the computer systems of the customer. In stage 2004, the quality manager develops a test script based on the project requirements and the specification. Using this test script, the quality manager in stage 2006 performs system testing on the software application.

Once the software application satisfies system testing, the customer is allowed access to the software application, and the program manager walks the customer through the software application in stage 2008. In one form, the project manager sends the customer any email containing access instructions, such as the URL address of the project server 136 and the directory in which the software application is stored. The programmer then walks the customer through the application and makes note of any changes that need to be made to the software application. After the customer walks through the software application with the quality manager, the customer either accepts or rejects the current version of the application in stage 2010. If the customer requires additional changes to be made, the project manager makes a note of these changes and records any feedback from the customer in stage 2012. The project manager generates a feedback list from these notes and reviews the list with the customer in stage 2014. If the customer wants the original feedback list changed (stage 2012), the feedback list is modified and re-presented to the customer for approval. Once the feedback list is approved, the quality manager in concert with the program manager notes any quality defects of the developer and logs these quality defects into the project database 112 in stage 2016. This information can be later used to adjust the reputation score for the particular developer. In one form, the quality score and delivery date are used as factors in determining the number of base reputation points the developer earns from the project.

In stage 2018, the feedback list along with a modification request is sent to the developer. In one form, an email is sent to the developer containing the requested changes to the software application. It should be appreciated that this feedback can be sent in other manners. At the same time, the quality manager develops a final test script for retesting the software application in stage 2006. As soon as the customer accepts the software application in stage 2010, the quality manager factors in a quality score for the project into the base reputation points earned by the developer in stage 2020. The documentation for the software application then is finalized and installation procedures are created in stage 2022. The documentation can includes any design documents, the original project request form, any contracts, the unit test checklist, readiness checklist, the final test script, an instruction manual, and/or other types of documentation. The installation procedures include instructions on how to formally accept the software application and how to set up for a final walkthrough. For supplying a successfully tested software application, the developer is paid a portion of the amount owed. In one form, 80% of the bid amount is paid. It should be appreciated that the developer can be paid at other times.

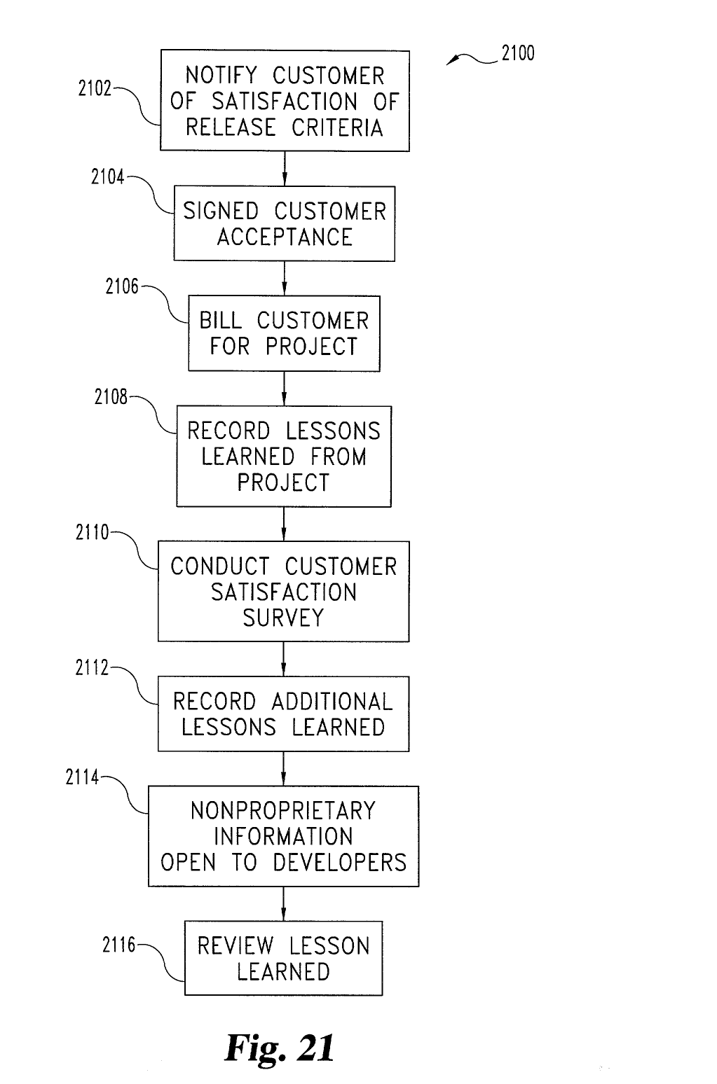

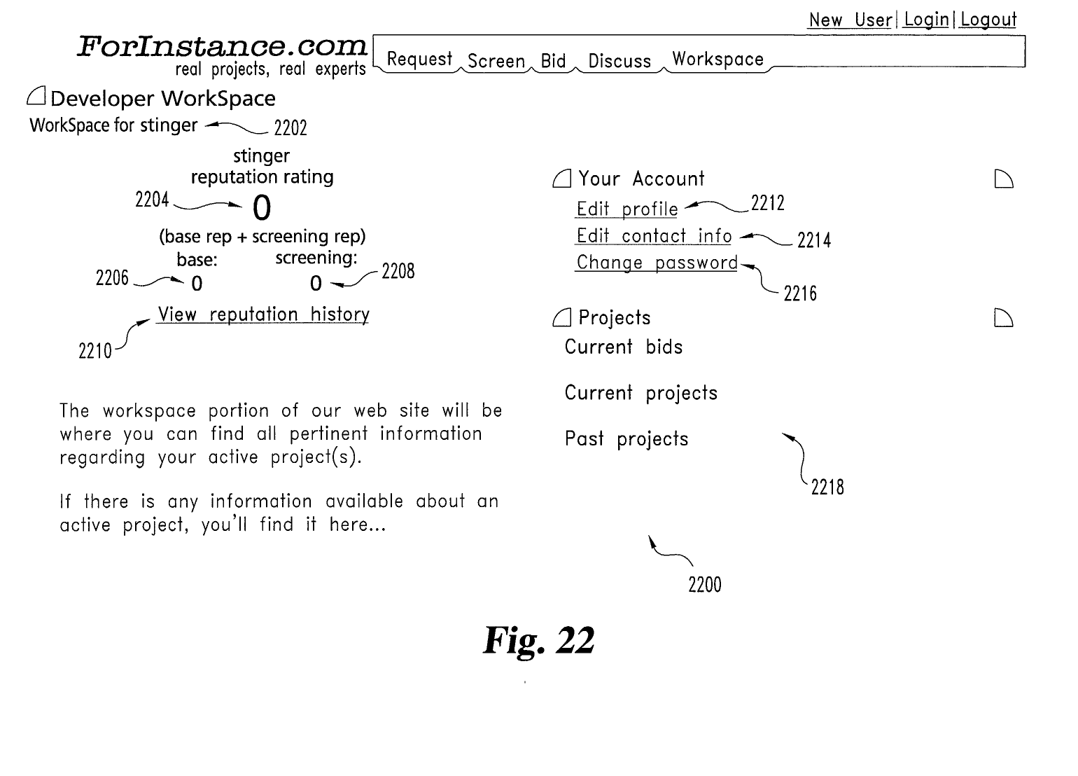

After the software application has been successfully tested, the project enters an implementation phase 212 (FIG. 2). Flowchart 2100, which is shown in FIG. 21, illustrates an implementation technique according to one form of the present invention. In stage 2102, the program manager notifies the customer that all of the criteria for the project have been satisfied. In one form, the project manager sends the customer an email notifying of that the criteria has been satisfied. For example, the email can state:

According to our quality tests, all criteria developed for your project have been successfully met the criteria initially designated by you, our customer. Please review the checklist located at http:// . . . and verify that all of the criteria have been met.

After the acceptance of the customer, the customer signs the customer acceptance agreement in stage 2104. The customer is then billed for the project in stage 2106. In one form, the customer is electronically billed, and in another form, the bill is sent through the postal system. At this point, the remainder owed to the developer is paid. It should be understood that the payment schedule can vary. For example, for very expensive projects, progress payments can be made throughout the project development process. For small projects, the full payment can be made at the completion of the project.

In stage 2108, the project and quality managers record in the project database 122 any lessons learned during the project. The managers enter any lessons learned into form 1200, which is shown in FIG. 12. This information can be later used to increase efficiency in developing other projects. After a period of time, for example one (1) month, a survey is conducted in stage 2110 to check customer satisfaction with the software application. Any additional information gleaned from the survey is entered into the project database 122 in stage 2112. Nonproprietary information, such as open source code, is made available on server 112 to the other developers in stage 2114. This nonproprietary information can be used in the development of other projects. Besides open source code, this information can include any pitfalls encountered during the project, any vendors used, program reviews, and other types of project related information. In stage 2116, all of the quality managers, project managers and operations personnel review the lessons learned from the project. In one form, weekly meetings are conducted to review the lessons learned. This helps to reduce the risk that the same problems will occur in other ongoing projects. As shown in FIG. 2, after implementation, the project enters a warranty phase 214. In the warranty phase, any warranty issues are handled by the project manager or the quality manager. The managers may contact the developer in order to resolve any warranty issues. It is envisioned the above-described methods can be encoded as logic that is transmitted over parts of computer network 106.

Although the present invention was described above in reference to a single group of managers, administrators, operations personnel, and salespersons, it should appreciated that multiple groups of overseers can form distinct “virtual” companies by hiring from a community of developers. Each of these virtual companies can have their own distinct market niche. For example, one virtual company can manage e-commerce projects, and another virtual company can manage marketing projects for a specific market segment. The community server 112 reduces transaction costs, which in turn makes the formation of these virtual companies easier.

While specific embodiments of the present invention have been shown and described in detail, the breadth and scope of the present invention should not be limited by the above described exemplary embodiments, but should be defined only in accordance with the following claims and their equivalents. All changes and modifications that come within the spirit of the invention are desired to be protected.

What is claimed is:

1. A method, comprising:
contracting with a customer to develop a project;
posting a description of the project at a site on a computer network that is accessible by a number of developers;
receiving one or more bids for the project from one or more of the developers over the computer network;
awarding the project to at least one selected developer from the developers based on the bids;
administering development of the project by the selected developer; and
supplying the customer a completed project.

2. The method of claim 1, further comprising obtaining a project request from the customer over the computer network before said contracting.

3. The method of claim 2, further comprising screening the project request with the developers.

4. The method of claim 2, further comprising evaluating the project request, said evaluating including comparing the project request to a job type template generated from at least one prior project.

5. The method of claim 1, further comprising recruiting a qualified developer based on a profile of the qualified developer stored in a database.

6. The method of claim 1, further comprising recruiting at least one of the developers over the computer network.

7. The method of claim 1, wherein said awarding, said administering, and said supplying occur over the computer network.

8. The method of claim 1, further comprising testing the completed project over the computer network.

9. The method of claim 1, wherein said administering includes checking status of the project at predefined milestones.

10. The method of claim 1, further comprising:
screening projects with the developers; and
adjusting the bids based on individual developer reputation scores.

11. The method of claim 1, wherein the project includes a software application development project, the computer network includes the Internet, the site includes a website, and the developers include a virtual community of remotely located software developers.

12. A method, comprising:
operating a project development server that is operatively coupled to one or more developer computers over a computer network, the server being operatively coupled to a customer computer over a computer network;
receiving a signal corresponding to a request for development of a project from the customer computer over the computer network;
sending one or more signals corresponding to a description of the project to one or more of the developer computers over the computer network;
receiving with the server one or more signals corresponding to one or more evaluations of the project from the developer computers over the computer network; and
sending to the customer computer a signal corresponding to an acceptance of the project based at least in part on the evaluations.

13. The method of claim 12, wherein the project development server includes a web server and the computer network includes the Internet.

14. A computer-readable device, the device comprising:
logic executable by a computer to adjust a bid for a project from a developer based on reputation, said logic being operable by said computer to receive the bid for the project from the developer over a computer network, said logic being further operable by said computer to maintain a reputation score for the developer, said logic being further operable by said computer to calculate an adjusted bid, wherein the adjusted bid corresponds to the bid from the developer proportionally adjusted with respect to the reputation score of the developer; and
wherein said logic is operable by said computer to provide the adjusted bid.

15. The device of claim 14, wherein the device includes a removable memory device and said logic is in a form of a number of programming instructions for said computer stored on said removable memory device.

16. The device of claim 14, wherein the device includes at least a portion of a computer network and said logic is in a form of encoding signals carried on said computer network.

17. The device of claim 14, wherein the reputation score includes base reputation points earned by the developer and participation points earned by the developer, the base reputation points are earned for timely completion of projects, and the participation points are earned for screening project requests.

18. The device of claim 14, wherein said logic is further operable by said computer to display the adjusted bid on a web page.
